(19) United States
(12) Patent Application Publication
(10) Pub. No.: US 2025/0014415 A1
(43) Pub. Date: Jan. 9, 2025

(54) WATERMARKED ELECTRONIC PULL-TAB GAMING SYSTEM AND METHOD

(71) Applicant: Pilot Gaming Systems, Inc., Reno, NV (US)

(72) Inventors: Jon Weaver, Birmingham, MI (US); Anthony M. Morelli, Mt. Pleasant, SC (US)

(21) Appl. No.: 18/765,249

(22) Filed: Jul. 6, 2024

Related U.S. Application Data
(60) Provisional application No. 63/660,506, filed on Jun. 15, 2024.
(60) Provisional application No. 63/525,593, filed on Jul. 7, 2023.
(60) Provisional application No. 63/525,644, filed on Jul. 7, 2023.
(60) Provisional application No. 63/525,646, filed on Jul. 7, 2023.
(60) Provisional application No. 63/525,647, filed on Jul. 7, 2023.

(51) Int. Cl. G07F 17/32

(52) U.S. Cl. CPC G07F 17/3213; G07F 17/329

(57) ABSTRACT

A watermarked pull-tab gaming system and method are described. The electronic pull-tab deck includes watermarked winning electronic pull-tab tickets having a non-zero win value. The gaming devices are communicatively coupled to the wagering system. Each gaming device includes a processor and a memory. The electronic pull-tab ticket request is generated by the gaming device. The gaming device receives an electronic pull-tab ticket in response to the electronic pull-tab ticket request. The electronic pull-tab ticket includes a watermark identifier. The watermark table is stored on the gaming device. The watermark table indicates a type of watermark and a placement of the watermark for a total prize award on the gaming device. The gaming device displays the watermark as indicated by the watermark table. The reveal animation that corresponds to the electronic pull-tab ticket is presented on the gaming device after the gaming device displays the watermark.

### CROSS-REFERENCES

This patent application claims the benefit of provisional patent application 63/525,593 entitled EMBEDDED FEATURE ELECTRONIC PULL-TAB SYSTEM AND METHOD, filed on Jul. 7, 2023;

this patent application claims the benefit of provisional patent application 63/525,644 entitled OVERLAID FEATURE ELECTRONIC PULL-TAB SYSTEM AND METHOD, filed on Jul. 7, 2023;

this patent application claims the benefit of provisional patent application 63/525,646 entitled PLACEHOLDER FEATURE ELECTRONIC PULL-TAB SYSTEM AND METHOD, filed on Jul. 7, 2023;

this patent application claims the benefit of provisional patent application 63/525,647 entitled ELECTRONIC PULL-TAB SYSTEM AND METHOD FOR MODIFIABLE PAYTABLES, filed on Jul. 7, 2023;

this patent application claims the benefit of provisional patent application 63/660,506 entitled WATERMARKED ELECTRONIC PULL-TAB GAMING SYSTEM AND METHOD, filed on Jun. 15, 2024, and

the above patent applications are hereby incorporated by reference in this patent application.

### FIELD

A watermarked electronic pull-tab gaming system and method are described. More specifically, the watermarked electronic pull-tab gaming system and method generates watermarked virtual pull-tab tickets having zero or non-zero win values. Each watermarked virtual pull-tab ticket is further associated with an initial reveal graphic that includes a game symbol sequence.

### BACKGROUND

Electronic pull-tab gaming is a form of gambling that is played on electronic devices, such as tablets or gaming machines. Electronic pull-tab gaming is like traditional paper pull-tab games where players purchase tickets with perforated tabs that can be pulled back to reveal symbols or numbers.

In electronic pull-tab gaming, players use a touch screen interface to select and purchase virtual pull tab tickets. The tickets are displayed on the screen, and players can swipe or tap the tabs to reveal the symbols or numbers underneath. The virtual pull-tab tickets are created with a random number generator, which ensures fairness and unpredictability.

Electronic pull-tab games often feature various themes and designs, with different symbols or numbers representing different prizes or payouts. Players can choose the amount they want to wager and the number of tickets they want to play. There is the potential to win different amounts depending on the combination of symbols or numbers revealed.

One advantage of electronic pull-tab gaming is its convenience and accessibility. Players can enjoy the game at any time and from anywhere with an internet connection. It also eliminates the need for physical tickets and manual tab pulling, which makes the gaming experience faster and more efficient.

Electronic pull-tab gaming is regulated by gaming authorities to ensure fairness and responsible gambling practices. Electronic pull-tab gaming systems are commonly found in casinos, gaming lounges, or online gambling platforms. Electronic pull-tab gaming provides entertainment and the opportunity to win prizes for players who enjoy this form of gambling.

There is a need to make electronic pull-tab gaming more exciting by creating a more suspenseful gaming environment that encourages more player engagement when presenting players with different types of prizes. The watermarked electronic pull-tab gaming systems and methods described hereinafter provide an entertaining gaming environment that rewards players with different types of prizes.

### SUMMARY

A watermarked pull-tab gaming system and method are described. The system includes a wagering system, gaming devices, an electronic pull-tab ticket having a watermark identifier, a watermark table, and a reveal animation. The wagering system generates an electronic pull-tab deck that includes electronic pull-tab tickets. The electronic pull-tab deck includes watermarked winning electronic pull-tab tickets having a non-zero win value. The gaming devices are communicatively coupled to the wagering system. Each gaming device includes a processor and a memory. The electronic pull-tab ticket request is generated by the gaming device. The gaming device receives an electronic pull-tab ticket in response to the electronic pull-tab ticket request.

The electronic pull-tab ticket includes a watermark identifier. The watermark table is stored on the gaming device. The watermark table indicates a type of watermark and a placement of the watermark for a total prize award on the gaming device. The gaming device displays the watermark as indicated by the watermark table. The reveal animation that corresponds to the electronic pull-tab ticket is presented on the gaming device after the gaming device displays the watermark.

In the illustrative embodiment, the electronic pull-tab ticket having the watermark identifier includes a total prize and a plurality of display information associated with the total prize.

In one embodiment, the watermark is displayed as a grid. In a further embodiment, the electronic pull-tab ticket having the watermark identifier and the watermark table associated with the gaming device determines one or more highlighted portions of the grid watermark.

In another embodiment, the watermark is embedded in a game symbol. In yet another embodiment, the watermark is proximate to a game symbol.

In a further embodiment, the reveal animation includes at least one of a screen shift, a foreground display, and a background display.

In a still further embodiment, the reveal animation includes an overlaid feature, wherein the overlaid feature is displayed on top of at least one of the plurality of game symbol display positions.

In an even further embodiment, the reveal animation includes one or more placeholder symbols, in which the placeholder symbol covers a game symbol and revealing the game symbol when the placeholder symbol is removed.

### BRIEF DESCRIPTION OF THE DRAWINGS

The present invention will be more fully understood by reference to the following drawings which are presented for illustrative, not limiting, purposes.

FIG. 1 shows an illustrative watermarked virtual pull-tab gaming system.

FIG. 2 shows an illustrative player interface unit, which may also be referred to as a pull-tab gaming client device with POS functionality.

FIG. 3 shows further detail of the wagering system communicatively coupled to different venues.

FIG. 4 shows an illustrative point-of-sale (POS) device communicatively coupled to authorized mobile devices in a gaming venue.

FIGS. 5A and 5B show a watermarked virtual pull-tab gaming method that operates with the illustrative watermarked virtual pull-tab gaming system.

FIG. 6 shows a screenshot of an illustrative start screen for the watermarked virtual pull-tab game Cash Mountain™.

FIG. 7 shows a screenshot of an illustrative final reveal screen for a Cash Mountain™ standard winning virtual pull-tab ticket.

FIG. 8A shows a screenshot of an illustrative initial reveal screen for a Cash Mountain™ watermarked virtual pull-tab ticket.

FIG. 8B shows an expanded inset view of a Cash Mountain™ game symbol and an embedded watermark graphic enhancement.

FIGS. 9A-9F show screenshots of an illustrative Cash Mountain™ perceived pick animation.

FIG. 10 a screenshot of an illustrative final reveal screen for a Cash Mountain™ watermarked virtual pull-tab ticket.

FIG. 11A shows a screenshot of an illustrative initial reveal screen for a Cash Mountain™ watermarked virtual pull-tab ticket.

FIG. 11B shows an expanded inset view a Cash Mountain™ game symbol and an embedded watermark graphic enhancement.

FIGS. 12A-12E show screenshots of an illustrative Cash Mountain™ roll-up animation.

FIG. 13 shows a screenshot of an illustrative final reveal screen for a Cash Mountain™ watermarked virtual pull-tab ticket.

FIGS. 14A-14K show a symbol combination paytable for the Cash Mountain™ watermarked electronic pull-tab game.

FIG. 15 shows an illustrative Fortune Freakz™ watermarked electronic pull-tab deck selection screenshot.

FIG. 16 shows a screenshot of an illustrative start screen for the watermarked electronic pull-tab game Fortune Freakz™.

FIG. 17 shows a screenshot of an illustrative final reveal screen for a Fortune Freakz standard winning virtual pull-tab ticket

FIG. 18A shows a screenshot of an illustrative initial reveal screen for a Fortune Freakz™ watermarked virtual pull-tab ticket.

FIG. 18B shows an expanded inset view of a Fortune Freakz™ game symbol and an embedded watermark graphic enhancement.

FIGS. 19A-19P show screenshots of an illustrative Fortune Freakz™ roll-up fight animation.

FIG. 20 shows a screenshot of an illustrative final reveal screen for a Fortune Freakz™ watermarked virtual pull-tab ticket.

FIGS. 21A-21D show a symbol combination paytable for the Fortune Freakz™ watermarked electronic pull-tab game.

FIG. 22 shows a screenshot of an illustrative character selection screen for the summer season version of the watermarked virtual pull-tab game Wild Walleye™.

FIG. 23A shows a screenshot of an illustrative start screen for the summer season version of the watermarked virtual pull-tab game Wild Walleye™.

FIG. 23B shows an expanded inset view of an animation graphic of a selected avatar character.

FIG. 24 shows an illustrative final reveal graphic for a standard winning Wild Walleye™ virtual pull-tab ticket.

FIG. 25A shows an illustrative winning system driven Game Event resulting from a winning sequence of symbols and an embedded watermark graphic enhancement.

FIG. 25B shows an enlarged view of the embedded watermark graphic enhancement and one game symbol of the winning sequence of symbols.

FIGS. 26A-26D show screenshots of an illustrative intermediate roll-up graphic animation.

FIG. 27 shows a screenshot of an illustrative final graphic animation for the watermarked virtual pull-tab game Wild Walleye™.

FIGS. 28A-28D show screenshots of illustrative game play of a standard winning Wild Walleye™ virtual pull-tab ticket.

FIG. 28E shows illustrative watermarks embedded in game symbols.

FIGS. 29A-29D show an illustrative symbol combination paytable for the Wild Walleye™ watermarked electronic pull-tab game.

FIG. 30 shows an illustrative character selection for the winter season version of the watermarked virtual pull-tab game Wild Walleye™.

FIG. 31 shows a screenshot of an illustrative start screen for the winter season version of the watermarked virtual pull-tab game Wild Walleye™.

FIG. 32 shows a screenshot of another illustrative character selection screen for the summer season version of the watermarked virtual pull-tab game Wild Walleye™.

FIG. 33A shows another screenshot of an illustrative start screen for the summer season version of the watermarked virtual pull-tab game Wild Walleye™.

FIG. 33B shows an enlarged view of an illustrative background animation graphic for a selected avatar character.

FIG. 34 shows yet another screenshot of an illustrative start screen for the summer season version of the watermarked virtual pull-tab game Wild Walleye™.

FIG. 35A shows yet another illustrative start screen for the summer season version of the watermarked virtual pull-tab game Wild Walleye™.

FIG. 35B shows an enlarged view of an illustrative background animation graphic for another selected avatar character.

FIGS. 36A-36D show another illustrative symbol combination paytable for the Wild Walleye™ watermarked electronic pull-tab game.

### DESCRIPTION

Persons of ordinary skill in the art will realize that the following description is illustrative and not in any way limiting. Other embodiments of the claimed subject matter will readily suggest themselves to such skilled persons having the benefit of this disclosure. The various illustrative embodiments will now be described more fully with reference to the accompanying drawings. It should be understood that this disclosure and the claims may be embodied in many different forms and should not be construed as limited to the embodiments set forth herein. Additionally, those familiar with computing systems shall appreciate that there are many variants possible for the described systems, depending on the nature of the available networks, legal frameworks, which can open or restrict the types of locations in which the system can be operated. Additionally, there may be advances in server and networking technologies that result in alternative embodiments that are practiced by those of ordinary skill in the art.

An electronic pull-tab game relies on a central determination system to generate random results. Central determination in a pull-tab game refers to the method by which the outcome of the game is determined. In traditional paper pull-tab games, the outcome is typically pre-determined and printed on the physical tickets. However, in electronic pull-tab games, the outcome is determined centrally by a random number generator (RNG) or a central computer system.

By using central determination, electronic pull-tab games can offer a wide range of outcomes, possibilities, and presentations, which creates excitement and suspense for players. Additionally, central determination allows for more flexibility in game design and the ability to offer progressive jackpots or bonus features that can be triggered based on the central determination system's results.

In operation, when a player purchases a virtual pull-tab ticket and reveals the symbols or numbers on the screen, the central determination system uses the RNG to select the specific ticket. Note, the outcome is already embedded in the ticket and the RNG is used to shuffle the order of the tickets. The RNG is a computer algorithm that generates random numbers or symbols, ensuring fairness and unpredictability in the game. The RNG operates independently of the player's actions and cannot be influenced or manipulated. The central determination system ensures that each ticket has an equal chance of winning or losing, providing a fair and transparent gaming experience.

There are various types of electronic pull-tab games available, in which each electronic pull-tab game has its own theme, design, and game play mechanics. Some common types of electronic pull-tab games include classic pull-tabs, multi-line pull-tabs, progressive pull-tabs, bonus feature pull-tabs, themed pull-tabs, and instant win pull-tabs.

Classic pull-tabs resemble traditional paper pull-tabs with simple game play and straightforward rules. During classic pull-tab game play, each player reveals symbols or numbers to determine their awarded prizes with classic electronic pull-tabs.

Multi-line pull-tabs feature multiple lines or rows of symbols, numbers, or scatters offering more chances to win. The exact paytable and combinations are revealed to the player on a paytable or flare. During multi-line pull-tab game play, players are awarded a prize by matching symbols or numbers horizontally, vertically, or diagonally.

Progressive pull-tabs operate by having a portion of each wager contribute to a progressive jackpot. During progressive pull-tab game play, the jackpot continues to grow until a player hits a prize combination that can result in substantial prize payouts.

Bonus feature pull-tab games include additional bonus features or mini-games that can be triggered by specific symbol combinations. During bonus feature pull-tab game play, bonus rounds may offer extra prizes or multipliers to enhance the gameplay experience.

Themed pull-tab games incorporate various themes, such as sports, fantasy, animals, or popular movies. The symbols and graphics in a themed pull-tab game are designed to match the theme and provide a more immersive and engaging gaming experience.

Themed pull-tab games incorporate various themes, such as sports, fantasy, animals, or popular movies. The symbols and graphics in a themed pull-tab game are designed to match the theme and provide a more immersive and engaging gaming experience.

Instant win pull-tab games offer immediate results, with players instantly knowing if they have won or lost. Instant win pull-tab games are designed for quick and easy game play and providing instant gratification.

For purposes of this patent, the term “Game Play” refers to player interactions with a pull-tab gaming client device and a network component, e.g., a server. Game Play occurs during a “Game Session” and may comprise one or more “Game Actions” and/or “Game Events.”

More specifically, Game Play occurs during a Game Session, in which a player engages with the electronic pull-tab client device for a time period. By way of example and not of limitation, a typical pull-tab Game Session begins when a player receives a mobile pull-tab gaming client device or sits down at a stationary pull-tab gaming client device. One or more Game Actions and/or Game Events may occur during a Game Session, such as by having the player select the electronic pull-tab game they want to play.

A Game Event, is a system driven occurrence that may occur independent of or in response to a Game Action. Exemplary Game Events include: generation of a virtual pull-tab deck; receipt of a virtual pull-tab ticket request; delivery of a requested virtual pull-tab ticket; redemption of a virtual pull-tab ticket value; Auto-Closing a virtual pull-tab deck; display of a requested virtual pull-tab ticket; display of a game animation associated with a virtual pull-tab ticket (i.e., a reveal animation, an initial reveal animation, an intermediate reveal animation, or a final reveal animation); and display of a virtual pull-tab ticket value/award/prize.

A Game Action is a player driven occurrence that may occur before, during, and/or after a Game Event. Exemplary Game Actions include: receipt of a mobile pull-tab gaming client device or placement at a stationary pull-tab gaming client device; selection of a game title; selection of a particular pull-tab deck as some games may have more than a single deck available per wager amount (e.g., decks may vary in volatility and prize distribution, decks may have the same distribution of prizes and be associated with a character, graphic theme, or other selection made by the player or the system, or some games may change between the Summer and Winter seasons); selection of a wager amount; selection of a number of virtual pull-tab tickets for purchase; purchase of the selected number of virtual pull-tab tickets; selection of a virtual pull-tab ticket to play; play a virtual pull-tab ticket; cashing out; other game interactions-such as selecting a lucky item; and returning the mobile pull-tab gaming client device or exiting from the stationary pull-tab gaming client device.

A “Game Instance” is Game Play that begins with the Game Action of a player selecting a particular virtual pull-tab ticket to play and ends with the Game Event of the gaming client device displaying a virtual pull-tab ticket value/award/prize, such that another Game Instance is available for play.

An illustrative Game Action that occurs before the Game Event of generating a random virtual pull-tab ticket includes having a player “select a wager amount.” The “select wager amount” Game Action occurs when the player decides on the amount they want to wager for each virtual pull-tab ticket.

Another Game Action that occurs before the “generate pull-tab ticket” Game Event includes the “purchase ticket(s)” Game Action, in which virtual pull-tab tickets are purchased. Also, there may be a separate “select the number of pull-tab tickets” Game Action where the player chooses the quantity of tickets to play during the game session. Thus, the “purchase tickets” Game Action and the “select the number of pull-tab tickets” Game Action results in the player purchasing and/or selecting the number of “deliver virtual pull-tab tickets” Game Events that occur to enable Game Play.

During Game Play, there are “player interaction” Game Actions that include having the player interact with a touch screen of the pull-tab gaming client device, such as “selecting a game title,” “selecting a wager amount,” “selecting virtual pull-tab ticket(s) for purchase,” “purchasing selected virtual pull-tab ticket(s),” “selecting a virtual pull-tab ticket to play,” “playing a selected virtual pull-tab ticket,” and “cashing out.” Embodiments of these player interaction Game Actions include having the player swipe or tap the tabs on the gaming client device to reveal the symbols or numbers underneath an image or icon. Also, there may be Game Play Game Actions, in which portions of the virtual pull-tab tickets are displayed on the screen of the client device.

The “play virtual pull-tab ticket” Game Action causes a “reveal” Game Event to occur, which displays the outcome associated with the virtual pull-tab ticket. The displayed outcome may be presented as symbols, numbers, or a combination thereof that represents the awarded prize. More specifically, the “reveal” Game Event provides a visual representation of whether the player loses, wins, or the win amount.

If the “reveal” Game Event displays a winning combination of symbols and/or numbers, the next Game Event is the display of the prize won. Prior to the display of the prize won, an entertaining Game Event may occur to reveal the prize amount of the virtual pull-tab ticket in some entertaining way other than merely a set of symbols. An animation of a character climbing to the top of a mountain may be shown to indicate that the player has won a large prize. Following the “display of prize” Game Event is the “payout” or “cash out” Game Action, in which the player receives a payout value based on a pull-tab game paytable. The prize awarded during the “payout” Game Event may depend on the wager amount, the specific symbols, the numbers matched, and/or any other bonus features or triggered multipliers.

After each Game Instance, there are various “continue game” player driven Game Actions. For example, the player may choose to continue game play by purchasing more pull-tab tickets or end the Game Session by cashing out their winnings and/or returning the mobile client device. Also, the player may decide to continue Game Play by selecting a different pull-tab game title, in which case the Game Session is continued.

The pull-tab gaming systems and methods described herein are also described as “watermarked electronic pull-tab” gaming systems and methods. “watermarked electronic pull-tab” gaming systems generate a watermarked virtual pull-tab deck having a plurality of different types of virtual pull-tab tickets in the watermarked virtual pull-tab deck. Thus, the single watermarked virtual pull-tab deck can generate different types of Game Events. Also, a particular set of Game Actions are associated with each type of Game Event. By comparison, a traditional pull-tab deck usually generates a single type of pull-tab ticket, which may also be described as a singular Game Event.

In the illustrative embodiments presented herein, the virtual pull-tab tickets may include standard no-prize pull-tab tickets (i.e., losing tickets), watermarked no-prize pull-tab tickets (i.e., watermarked losing tickets), standard winning pull-tab tickets, and watermarked winning pull-tab tickets. The inventors theorize that watermarked losing pull-tab tickets, watermarked winning pull-tab tickets, or any combination thereof may engage with player psychology in a manner that creates increased anticipation or suspense during instances of game play and extended game sessions. The inclusion of a watermark, even on a losing ticket may provide players the appearance of a win and delay resolution of the anticipation associated with a potential win, increasing player engagement and desire to play. Further, the association of embedded watermark graphic enhancements with winning animations and/or increased win values may drive increased anticipation of a win value during any later display of the embedded watermark graphic enhancements.

More generally, the pull-tab gaming systems and methods presented herein support centralized control of electronic pull-tab ticket wagering with virtual pull-tab tickets. The electronic pull-tab gaming systems and methods described herein are placed in one or more wagering venues. A wagering or gaming venue includes a charity, a casino, and any other such authorized or licensed gaming venue. Additionally, a gaming venue includes a church, hotel, bar, restaurant, convenience store and other such locations that support licensed gaming activity. Note, that the term “gaming” refers to games of chance or games that include a chance component, in which a wager is received, and the awarded prize is dependent on the outcome of the game of chance or of the chance component.

As described in further detail, the gaming systems and methods presented herein are communicatively coupled to a plurality of remote gaming venues, in which each remote gaming venue has at least one client device that supports customer wagering. The client devices supporting customer wagering may include fixed cabinet machines (e.g., electronic gaming machines (EGMs), slot machines, and mechanical reel type machines) and mobile gaming devices (e.g., smartphones, authorized mobile gaming devices, and player interface units). Additionally, each remote gaming venue may include one or more Point-of-Sale (POS) stations that manage player funds. In the illustrative embodiments presented herein, the various elements of the gaming system are communicatively and operatively coupled to one another with a secure network architecture that includes the Internet as the backbone and at least one secure Wi-Fi network within each gaming venue.

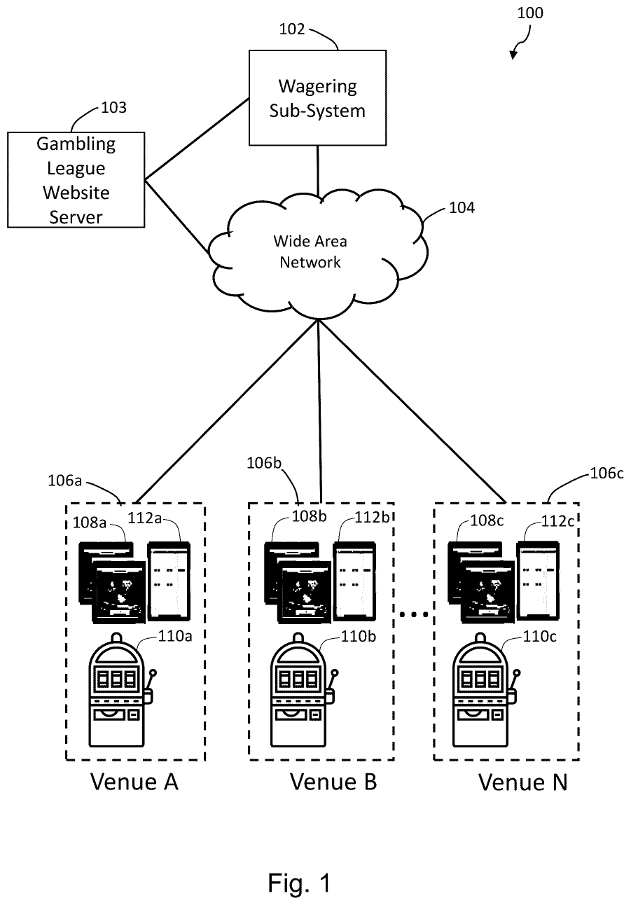

Referring to FIG. 1, there is shown an illustrative electronic pull-tab gaming system. The electronic pull-tab gaming system 100 includes a wagering system 102 that can manage and operate the electronic pull-tab gaming systems and methods described herein. The wagering system 102 is communicatively coupled to a Wide Area Network 104, e.g., Internet. Additionally, the wagering system 102 is communicatively coupled to a plurality of gaming venues, namely, illustrative gaming Venue A 106a, Venue B 106b and other such gaming venues as represented by Venue N 106c.

In the illustrative embodiment, each gaming venue may be associated with a sponsoring organization, e.g., a charity and a distributor. The types of venues, sponsoring organizations, and other such business entities vary according to jurisdictional statutes and state or local regulation.

In the illustrative embodiment, each of the gaming venues 106a, 106b and 106c may include a plurality of authorized mobile devices 108a, 108b and 108c, respectively. Additionally, each of the gaming venues 106a, 106b and 106c may include a plurality of non-mobile or stationary gaming devices 110a, 110b, and 110c, respectively.

The authorized mobile devices 108 and non-mobile gaming devices 110 may also be referred to as “gaming devices” or “pull-tab gaming client device” depending on the context. Furthermore, each of the gaming venues includes at least one Point-of-Sale (POS) device 112a, 112b, and 112c. The illustrative authorized mobile devices 108 and the POS devices 112 are client devices configured to communicate with each other and the wagering system 102.

In operation, the authorized mobile devices 108, non-mobile gaming devices 110, and POS devices 112 are registered with the wagering system 102, which includes a database (not shown) that associates the authorized mobile devices 108, non-mobile gaming devices 110, and POS devices 112 with a designated gaming venue 106. The authorized mobile devices 108 and POS devices 112 are not allowed to interact with the electronic pull-tab gaming system 100 when such client devices are not located at the designated gaming venue 106.

The illustrative authorized mobile devices 108 operate as wireless client devices that are communicatively coupled to the electronic pull-tab gaming system 100. Additionally, the electronic pull-tab gaming system 100 may be communicatively coupled to authorized non-mobile clients such as stationary gaming devices 110. Furthermore, other client devices such as non-mobile clients may be disposed in the gaming venues and these non-mobile clients may also be communicatively coupled to the electronic pull-tab gaming system 100.

The authorized non-mobile client devices 110 include, but are not limited to, wired devices such as stationary gaming machines, slot machines, PCs, stationary monitors, Internet appliances, Internet of Things (IoT) devices and other such non-mobile devices with hardwire connections or wireless connections to the Wide Area Network 104. The non-mobile client devices may be configured to participate in the games presented herein including, but not limited to, the tournament games described hereinafter.

Operationally, the illustrative pull-tab gaming client devices must comply with the system-centric gaming requirements, in which all gaming and accounting activity are controlled by the wagering system 102. Also, the wagering system 102 has the communications infrastructure, directly or by proxy, to interact with the pull-tab gaming client devices 108 and 110 described herein.

The illustrative electronic pull-tab gaming system 100 includes a plurality of server-side applications that are configured to provide high-availability and redundancy and process various instructions that are received from other servers, virtual machines, and client devices. The gaming system 100 also generates outputs related to game play. The illustrative electronic pull-tab gaming system 100 includes three different types of network communications. Firstly, there are network communications between the server-side components. Secondly, there are network communications between the server-side components such as the wagering system 102 and the illustrative remote gaming venues 106a, 106b and 106c. The electronic pull-tab gaming system 100 may also interface with an illustrative gambling league website server 103. Thirdly, there are separate network communications within the gaming venues 106a, 106b, and 106c. This illustrative system 100 may be applicable in a jurisdiction in Minnesota.

In an alternative offline embodiment, a local site server disposed at a particular gaming location includes a cache of tickets that may be comingled so that more than one deck for a wager and theme is in play at any given time and the system makes a random or alternating purchase from the different active decks matching the player's selection. This alternative offline embodiment may be applicable in North Dakota. Other system embodiments that comply with local regulations would readily suggest themselves to those of ordinary skill in the art having the benefit of this description and the drawings.

With respect to network communications between the server-side components which operate as a single network, the plurality of server-side component communicates with one another using service requests. By way of example and not of limitation, the illustrative internal server components have two internet protocol addresses, namely, a private IP address used to maintain the server network and ensuring secure server-to-server communication, and a public IP address that is bound to the Internet and that provides access to server services through high security communications such as Hypertext Transfer Protocol Secure (HTTPS). The internal server components may use their private IP addresses for server-to-server communications so that these services are not exposed to the Internet.

By way of example and not of limitation, each illustrative server is configured with an SSL certificate that supports HTTPS calls. The illustrative server is configured to forward some requests it receives through HTTPS to a local port, and the requests that are allowed to pass are only those available to authorized gaming devices and POS devices.

By way of example and not of limitation, the server-side components and/or servers are implemented using the Linux operating system using Restful programming techniques with Java as the programming language and having Jersey RS support and the database structures are contained in an illustrative MySQL database.

Communication between the server-side components, namely, the wagering system 102, and the remote gaming client devices is performed over a wide-area network 104, and these network communications are performed using secure SSL communications over the Internet.

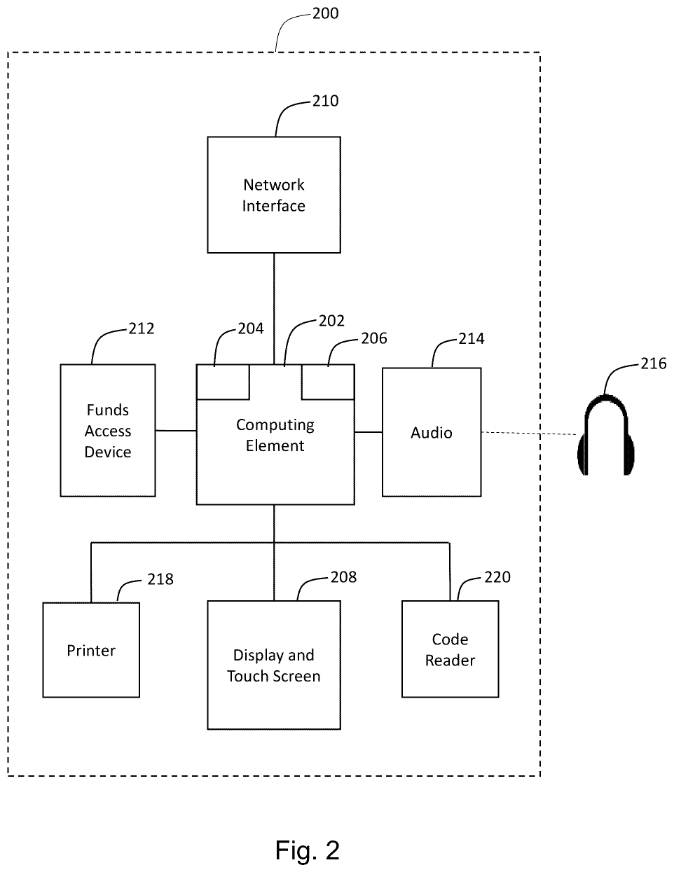

For purposes of this patent, the authorized mobile devices 108a, 108b and 108c are also referred to as a “player interface unit.” An illustrative authorized mobile device is presented in FIG. 2. Operationally, each authorized mobile device 108 in the illustrative embodiments are each associated with a player account.

By way of example and not of limitation, the player account is described as a short-term, anonymous entity tied to the client device being used by the player, and which expires when the fund balance drops to zero. However, it is possible in other embodiments to have player accounts which may exist for longer time periods and be tied to a player regardless of a zero balance.

Additionally, it should be noted that while the illustrative embodiments presented herein generally describe financial transactions such as adding funds or cashing out at the POS device 112, in different regulatory environments or with different technology, such player accounts can have financial transactions originating at the player device or any other client device that may be configured to support POS transactions. Also, financial transactions may be supported at a system level with a server component or server module that provides web portal functions for financial transactions. Thus, the financial transactions may be performed by the client device, a server component, a server module, or any combination thereof. Depending on regulatory issues and available technology, financial transactions may be based on cash, credit cards, debit cards, digital currency, or other mediums of finance.

Referring to FIG. 2, there is shown an illustrative player interface unit 200, which may also be referred to as a pull-tab gaming client device with POS functionality. The illustrative player interface unit 200 may include the authorized mobile device 108, the point-of-sale device 112, and any combination thereof. Thus, the distinction between the gaming device in FIG. 1 and the player interface unit 200 is that the player interface unit 200 may also operate as POS device and as a gaming device.

For example, the illustrative player interface unit 200 may be one of the plurality of authorized mobile devices 108 that is associated with each venue. The illustrative player interface unit 200 includes a central computing element 202 with a processor 204 and memory storage 206. One or more games may be pre-installed on the player interface unit 200 before the player interface units are deployed in a gaming venue or other such production environment. Alternatively, the illustrative game title files may be stored in a remote server, e.g., an “App” store, and the player interface unit 200 may be configured to download the game title file, run the game title file, and enable the user to interact with the corresponding game title.

The player interface unit 200 also includes a touch screen color display 208 and a network interface component 210, which provides network access to a local area network, a wide area network or any combination thereof. By way of example and not of limitation the network interface component supports a wireless local area network such as a Wi-Fi network, which is based on IEEE 802.11 standards. Additionally, the player interface unit 200 may communicate with the wide area network 104 via the illustrative Wi-Fi network. The communication between the player interface unit 200 and the mobile wagering system 102 may be performed using the illustrative HTTPS protocol or other such secure networking protocol that allows game session inputs, commands, and outputs to be communicated securely across the Wide Area Network.

In an illustrative embodiment, the player interface unit 200 may be a tablet computing device running iOS or Android operating systems. The illustrative player interface unit may also include a Funds Access Device module 212 that may be configured to have a custom locked profile to evade security-bypassing attempts. The Funds Access Devices 212 may also provide alternative methods for starting play sessions or adding funds to existing sessions. By way of example and not of limitation, the Funds Access Device module 212 may include currency readers and debit/credit card readers such as a magnetic stripe reader, a smart-card reader, an infra-red reader, a Near-Field-Communications reader and other such financial transaction readers.

The player interface unit 200 may also include an audio system component 214 that enhances the game-playing experience for the players. The audio system component 214 may also include a standard audio jack so that a player can use wired or wireless headphones 216 to improve the game audio environment without disturbing others.

In one illustrative embodiment, the player interface unit 200 may include a printer 218 and a code reader 220. By way of example and not of limitation, the printer 218 generates vouchers. The illustrative code reader 220 may be embodied as a bar-code reader that is configured to read vouchers generated by the printer.

By way of example and not of limitation, the player interface unit 200 may be configured to include a “HELP” button in the game client device that also dispatches a signal to the POS to notify the operator that the player is requesting assistance. The player interface unit 200 may also be configured to include text-to-speech functionality to aid a visually impaired player. Additionally, the player interface unit 200 may include a gaming application that downloads files, decompresses the downloaded files if they have been compressed, and caches all assets inside the player interface unit 200. The player interface unit 200 supports dynamic updates without the need to update the game client itself.

Referring now to FIG. 1 and FIG. 2, the wagering system 102 is communicatively coupled to a plurality of authorized non-mobile devices 110 and mobile devices 108 such as illustrative player interface unit 200 presented in FIG. 2. In one illustrative embodiment, the wagering system 102 receives a wager input for a game session from the illustrative player interface unit 200. In another illustrative embodiment, the wagering system 102 receives the wager input for a game session from a plurality of authorized non-mobile devices 110 and mobile devices 108, which may be disposed at one or more venues as presented in FIG. 1.

The illustrative player interface unit 200 presents a user interface on touch screen 208 that shows a plurality of game content associated with different types of game sessions. In the illustrative embodiment, the player interface unit 200 may also accept player inputs that are associated with a game session. The game session may perform various operations as described in further detail below.

Referring to FIG. 3, there is shown further detail for the wagering system 102 communicatively coupled to different venues. In an illustrative embodiment, the wagering system 102 functionality is distributed on server-side components such as the multiple servers shown in FIG. 3, including those that provide database 314 functionality. The illustrative wagering system 102 maintains authority over game operations controlled by the electronic pull-tab gaming system 100 and includes a site director server 302 that operates as a coordinating entity for system operation, handles graphics, directs configuration of gaming devices and downloads of applications thereto. The wagering system 102 also includes a distributor server 304 that is communicatively coupled to the gaming devices at each venue 306, 308, 310, and 312 through the router 320.

In the illustrative embodiment presented, a first distributor server 304a and second distributor server 304b are communicatively coupled to the site director server 302. Each of the illustrative distributor servers 304 are configured to manage and control the game operations and cashier operations performed at a set of gaming venues that are associated with a distributor. The distributor is responsible for sales and support of a multiplicity of venues.

For example, gaming venues 306 and 308 are configured to communicate with first distributor server 304a, which manages and controls the game operations at gaming venues 306 and 308. A second set of gaming venues 310 and 312 are configured to communicate with second distributor server 304b, which manages and controls the game operations at gaming venues 310 and 312. Thus, multiple gaming venues may require additional distributor servers.

A variety of tasks may be performed by the site director server 302. For example, one of the tasks performed by the site director server 302 includes providing a central routing operation for each of the authorized gaming devices 108, 110 so that each authorized gaming device 108, 110 is routed to the proper distributor server 304a or 304b, game server (not shown), and manufacturer server 307 upon activation of each authorized gaming device. By way of example and not of limitation, the first request generated by a player interface unit 200 may direct the player interface unit 200 to an illustrative distributor of the player interface unit 200.

For another example, one of the tasks performed by the site director server 302 includes performance of initial authentication through https secure socket layers of gaming device unique identifiers, such as MAC IDs on boot up of a respective gaming device. In an illustrative embodiment, the site director 302 authenticates a gaming device's unique identifier by comparing a received unique identifier to a list of authorized unique identifiers stored in an authentication database (not shown).

For a further example, one of the tasks performed by the site director server 302 includes communication of a manufacturer server 307 URL and a distributor server 304 URL.

Additionally, the site director server 302 may be configured to provide a central routing operation for cashier authentication. For example, a cashier device may be authenticated by the appropriate distributor server 304, which may then forward an authentication to an illustrative mobile device distributor (not shown). Decks are generated by the deck generator. The site director has the capability to tell which systems authorized devices should be communicating with and other configuration details.

No-prize pull-tab tickets are losing tickets that award no prize for the system driven Game Event associated with the ticket, i.e. a no-prize or no-value system driven Game Event. Watermarked no-prize pull-tab tickets are losing tickets that award no prize for the system driven Game Event associated with the ticket, i.e., a no-prize or no-value system driven Game Event. Watermarked no-prize pull-tab tickets may include multi-staged graphic animation reveals including an initial or intermediate reveal including a watermarked symbol that may limit a player's ability to discern that the ticket is a losing ticket. Standard winning pull-tab tickets are winning tickets that award a standard prize for the system driven Game Event associated with the ticket, i.e., a standard winning system driven Game Event. In some embodiments, a standard winning pull-tab ticket may award a non-zero value prize. Watermarked winning pull-tab tickets are winning tickets that award a non-zero value prize for the one or more system driven Game Events associated with the ticket, i.e., an initial reveal graphic animation system driven Game Event, an intermediate reveal graphic animation system driven Game Event, and a final reveal graphic animation system driven Game Event. In some embodiments, a watermarked winning pull-tab ticket may award a non-zero value prize.

In an illustrative embodiment, the mobile wagering system 102 includes a separate deck generator server 305 that operates as the central authority for generation of finite pool decks of predetermined electronic pull-tab results. In these embodiments, the deck generator server 305 is communicatively coupled to one or more of the distributor servers 304a and 304b, as well as to the site director server 302, and the manufacturer server 307. The deck generator server 305 both randomizes the decks of electronic pull-tabs and distributes the decks to the manufacturer server 307. The manufacturer server 307 then virtually assigns each deck to one of the site locations 306, 308, 310, and 312 and distributes randomized tickets from the decks to gaming devices in those site locations.

In another illustrative embodiment, a separate system (not shown) may be responsible for generation of one or more finite decks, in which a server (not shown) may communicate with a deck generator server (not shown) to randomize finite pool decks.

The illustrative distributor servers 304 are communicatively coupled to the site director server 302. Each of the distributor servers 304 may be configured to manage finances for the player accounts that are associated with the authorized mobile devices. Additionally, the illustrative distributor servers 304 may be responsible for generating logs and reports required for the POS devices. Furthermore, the illustrative distributor servers 304 may be configured to manage game play operations, wagers, and prizes. Further still, the illustrative distributor servers 304 may manage cashier operations including customer sales and redemptions. Further yet, the distributor servers 304 may be configured to maintain the financial status for the authorized mobile devices, including the actual credit balance on each player device.

In an alternative embodiment, the operations performed by the site director server 302 and the distributor server 304 may be performed by a site director software module (not shown) and a distributor software module (not shown) that may be associated with a client-server architecture, a distributed architecture, a peer-to-peer architecture, a hierarchical architecture, a “cloud” architecture, or any combination thereof.

The mobile wagering system 102 may also include an illustrative web portal server 316. The web portal server 316 provides a web interface to access system accounting and operational data, as well as to maintain and configure the system. The web portal server 316 is configured to support creating, editing, and removing entities like distributors, operators, venues, cashiers, devices, game parameters and others as required. All actions performed on the portal are logged for auditing purposes. This action log can be accessed on the portal itself if the user has the necessary system privileges.

Additionally, the pull-tab gaming system and method operating on the wagering system 102 may be embodied in a fixed slot machine style cabinet communicatively coupled to one or more servers, such as a Casino Management System (CMS), which is well known in the art. The illustrative CMS server would operate as a network component.

By way of example and not of limitation, the web portal server may be accessed from personal computers or tablet devices 318 over the internet. Authorized users having “administrator” privileges may access system reports and controls based upon their operational needs and organizational affiliation. The web portal server 316 supports a variety of different authorized users having different roles with different levels of access to the mobile wagering system 102. For example, the web portal server may be configured to support the following roles: regulator, manufacturer, distributor with access to multiple operators, operator with access to multiple venues, a particular venue, a particular cashier, and other such preconfigured roles.

An illustrative router 320 is disposed within the wagering system 102. The router 320 is communicatively coupled to a wide area network 322, e.g., Internet, which is communicatively coupled to the various venues and authorized users. Additionally, the illustrative router 320 is communicatively coupled to the portal server 316, each distributor server 304, and the site director server 302. The router 320 forwards data packets to the appropriate server, network, internet appliance, system, and other such destination. Additionally, the router 320 may include a firewall that supports secure communications with the mobile wagering system.

The portal server 316 provides a web interface to access system accounting and operational data, as well as to maintain and configure the system. The web portal server is configured to support creating, editing, and removing entities like distributors, operators, venues, cashiers, devices, game parameters and others as required. All actions performed on the portal are logged for auditing purposes. This action log can be accessed on the portal itself if the user has the necessary system privileges.

The distributor servers 304 are communicatively coupled to the gaming devices at each venue. Each of the illustrative distributor servers are configured to manage and control the game operations and cashier operations performed at a set of gaming venues that are associated with a distributor. The distributor is responsible for sales and support of a multiplicity of venues.

The deck generator server 305 operates as the central authority for generation of finite pool decks of predetermined electronic pull-tab results. In these embodiments, the deck generator server is communicatively coupled to one or more of the distributor servers X, Y, Z, as well as to the manufacturer server. The deck generator server both randomizes the decks of electronic pull-tabs and distributes the decks to the manufacturer server. The manufacturer server then virtually assigns each deck to one of the site locations. The distribution server distributes randomized tickets from the decks to gaming devices in those site locations.

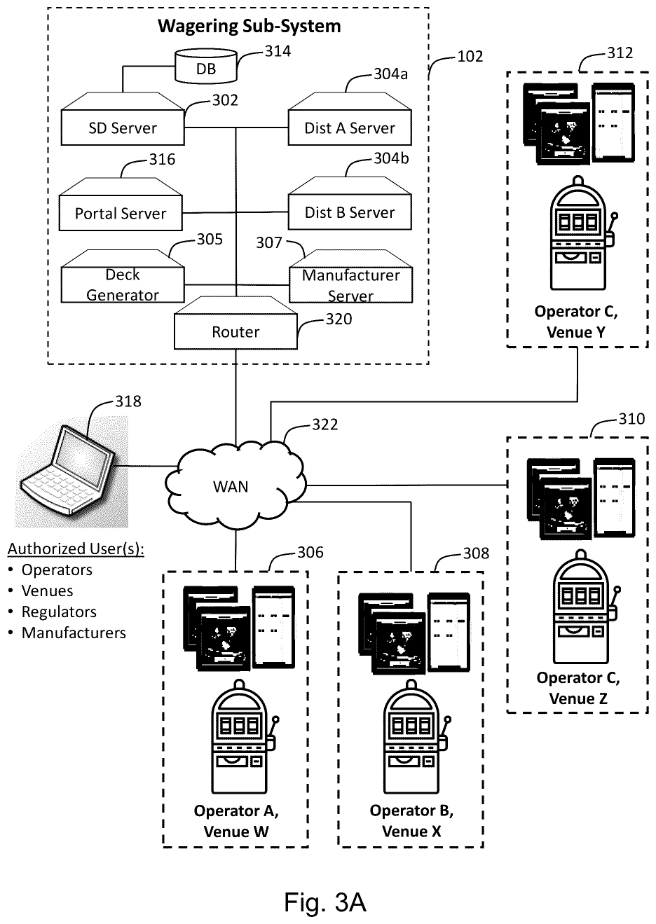

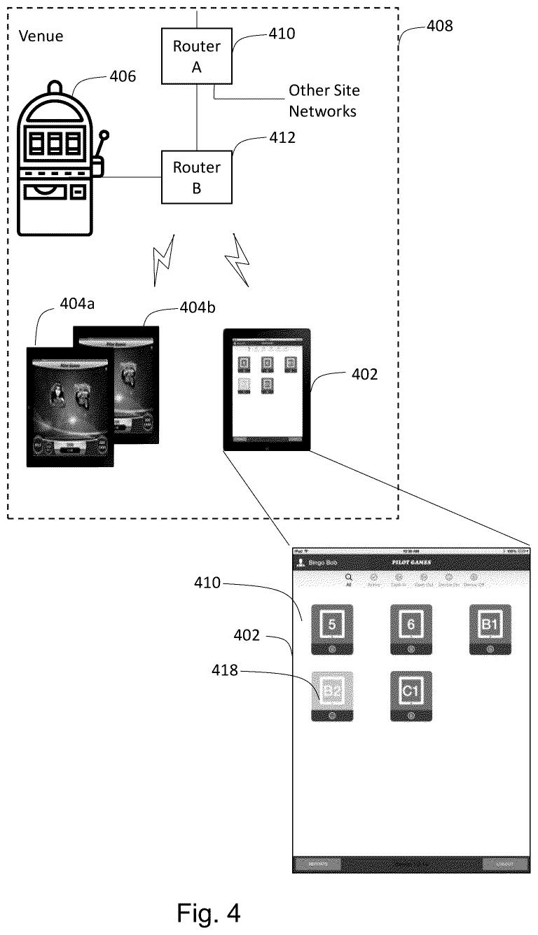

Referring to FIG. 4, there is shown an illustrative point-of-sale (POS) device communicatively coupled to authorized mobile devices in a gaming venue. The illustrative POS device 402 is communicatively coupled to one or more authorized mobile devices 404a, 404b and to one or more non-mobile gaming device 406 in gaming venue 408. By way of example and not of limitation, the illustrative POS device 402 is communicatively coupled to authorized mobile devices with a native socket implementation inside a Local Area Network. An exploded view of an illustrative user interface 410 corresponding to POS device 402 is also shown.

The point-of-sale device 402 is configured to manage all cash operations such as cash-in operations and cash-out operations. The cash-in and cash-out operations may be requested by the authorized mobile devices 404a, 404b, the authorized non-mobile device 406, the POS 402 or any combination thereof.

The illustrative point-of-sale (POS) device 402 and authorized mobile devices 404a and 404b may be embodied as a mobile device, e.g., player interface unit 200, as described above in FIG. 2. The illustrative POS device 402 is a client device configured to receive and operate an illustrative proprietary POS application. The authorized mobile devices 404a and 404b are client devices configured to receive and operate a proprietary game application. The illustrative POS device 402, the non-mobile devices 406, and authorized mobile devices 404a and 404b are communicatively coupled with the wagering system 102. In the illustrative embodiment, the client devices communicate with the wagering system 102 for each transaction.

More generally, all wagering and accounting information is monitored and stored in the gaming system 100 and the client devices always reflect the information received from the gaming system 100. For security and consistency, all game play decisions and financial data are hosted in the centralized gaming system and only visually reflected in the client devices.

Illustrative Wide Area Network 104, e.g., Internet, (shown in FIG. 1) is communicatively coupled to the illustrative gaming venue 408. In the illustrative embodiment, the illustrative wide area network terminates at Router A 410. The illustrative Router A 410 may be a pre-existing router located at venue 408 and usable for multiple purposes, depending on the needs of the venue. For example, Router A 410 may be a DOCSIS compliant component of a cable system. In the illustrative embodiment, a second Router B 412 is also communicatively coupled to router A 410. Illustrative Router B 412 may be configured to support the requirements for communications with the wagering system 102 and video presentation system 104.

In the illustrative embodiment, router B 412 establishes one or more private Wi-Fi SSIDs to be used only at a specific site. Each Wi-Fi SSID includes a security key that is unique to that site and is not available to site personnel. One SSID may be used for the exclusive use of the wagering system 102.

The illustrative POS 402 tablet is an electronic device that may be operated by a cashier located at a venue. The POS device 402 provides control over financial activity within the venue. The illustrative POS application program runs on a tablet device and supports the following illustrative operations, namely, a cash-in operation (sales), a cash-out operation (redemption) and a reporting operation.

In the illustrative embodiment, the cashier logs into the POS application program by providing a cashier username and password. During the set-up process, the cashier's name is associated with a cashier role that is associated only with a particular venue. After a successful login, the POS client retrieves relevant system information from an illustrative distributor server 304, which presents the user interface 410.

The illustrative user interface 410 associated with POS client 402 presents colored icons, in which each icon represents one of the authorized mobile devices (such as authorized mobile devices 404a and 404b) or non-mobile devices 406 in venue 408. For POS operations, the illustrative authorized mobile devices 404a, 404b and non-mobile device 406 may also be referred to as “a registered gaming client” or “requesting gaming device.”

By way of example, each icon 418 has a short identifier representing the local identification of the device, which is unique within that venue. For example, a grey icon may identify that the authorized gaming device has been registered with the wagering system; however, the authorized gaming device is not currently available for game play. Another illustrative icon may be a yellow icon, which represents that the authorized gaming device is present and available. A green icon may represent that the authorized gaming device has credit and is involved in a game session. A red icon may represent that a player input has been received that relates to a HELP button input command, a cash input command, or a cash output command.

In operation, a cashier interacts with user interface 410 and selects an icon associated with a particular authorized mobile device. After selecting the appropriate authorized mobile device, the cashier interacts with another user interface that enables the cashier to add cash to the authorized mobile device. The user interface available to the cashier may also enable a player cash-out from the authorized mobile device. Additionally, the cashier user interface may display a log of recent play and transactional activity, which may be retrieved from the illustrative site director server, the distributor server, or any combination thereof.

A variety of other user interfaces may also be presented in the point-of-sale device. For example, a user interface may be presented that allows the cashier to access reports and to log-out from the POS device. For example, a reports screen may be presented that summarizes the business activity of the current day, the previous day, or a historical period. The reports may include data regarding cash-in sales (in dollars), awarded prizes (in dollars) and net revenue (which is the difference between the cash-in sales and the awarded prizes). The illustrative reports screen may be refreshed in real time or in pseudo real time.

By way of example and not of limitation, a player may interact with the centralized gaming system 100 by purchasing play credits at the POS device 402. For example, the illustrative player requests an amount of credit and pays the cashier that is interacting with POS device 402. Subsequently, a POS session is established with the central database 314 (shown in FIG. 3) when the illustrative distributor server 304 receives a cash-in message from the POS client device 402. The illustrative cash-in message identifies the session amount and identifies the authorized gaming device associated with the POS session amount, which is linked to the identity of the POS device initiating the transaction. The distributor server 304 acknowledges the POS transaction and provides updated information to the specific game client indicating the amount of available at credit. Additionally, a player may elect to add credit to an existing balance by purchasing such credit from a cashier, who may use a POS ADD CASH function to record the transaction in the server database and update the available credit total.

The electronic pull-tab gaming system 100 described in FIG. 1 through FIG. 4 supports a variety of different types of games and game play, including electronic pull-tab game play of watermarked virtual pull-tab tickets incorporating no-prize pull-tab tickets, standard winning pull-tab tickets, and watermarked winning pull-tab tickets. For the illustrative wagering system 102, a Game Instance is initiated after a wager is received and the game instance ends when game play corresponding to the game instance is completed.

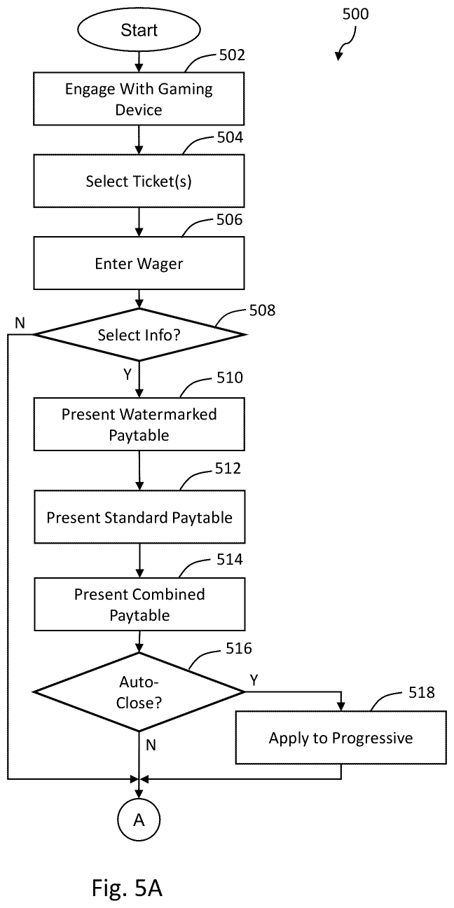

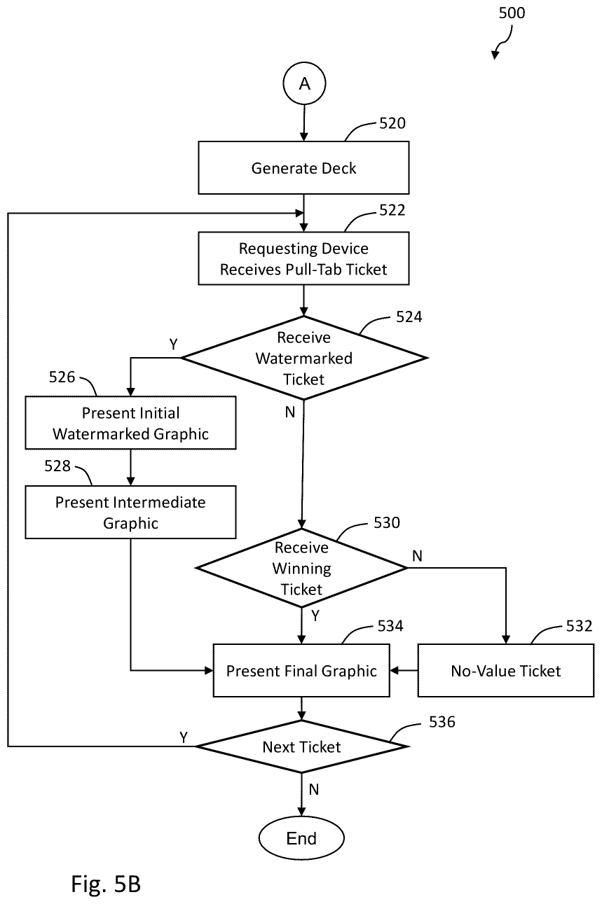

Referring to FIG. 5A and FIG. 5B, there is shown a watermarked electronic pull-tab gaming method 500 that operates with the illustrative electronic pull-tab gaming system 100. Alternatively, the watermarked electronic pull-tab gaming method 500 may be practiced with another system architecture that supports the player driven Game Actions, system driven Game Events, and Game Play of the watermarked electronic pull-tab gaming method 500.

In the illustrative embodiment, the electronic pull-tab gaming system 100 generates a “watermarked virtual pull-tab deck” as previously described. The watermarked virtual pull-tab deck includes a plurality of different types of virtual pull-tab tickets. In the illustrative embodiment, the watermarked virtual pull-tab deck includes a standard winning virtual pull-tab ticket type, a watermarked winning virtual pull-tab ticket type, and a no-prize virtual pull-tab ticket type.

The no-prize virtual pull-tab tickets have zero value. The standard winning pull-tab tickets and the watermarked winning virtual pull-tab tickets award a prize that has a non-zero value. No-prize virtual pull-tab tickets may have one of a plurality of symbol combinations that are all associated with the zero value of the no-prize tickets.

The watermarked electronic pull-tab gaming method 500, begins by initiating a Game Session at block 502. A Game Session may start when a player engages with a client gaming device, such as a mobile tablet or a stationary kiosk or bar-mounted device. Thus, a Game Session may begin when a player receives a mobile tablet or when a player seats themselves at a stationary device.

Upon initiating a game session at block 502, the method 500 proceeds to block 504 where a player performs the Game Action of selecting one or more virtual pull-tab tickets from one or more watermarked virtual pull-tab deck game titles. This step may include selecting the particular game title of the watermarked virtual pull-tab tickets that the player desires to purchase and play.

At block 506, the player performs the Game Action of entering a wager that is received by the wagering system 102. The Game Action of entering a wager may comprise player input that selects a per ticket wager amount each of the one or more tickets selected by the player in step 504. The Game Action of entering a wager may further comprise player input that purchases the one or more selected tickets.

The illustrative electronic pull-tab gaming method 500 continues at decision diamond 508 where a player may select the “info” button on their electronic pull-tab gaming device to view the watermarked virtual pull-tab paytable. If the player decides to view the watermarked virtual pull-tab paytable, the different prizes and ticket quantities are displayed to the player.

The watermarked virtual pull-tab paytable is accessed when the player selects the “info” button on a multi-tab gaming device. The watermarked virtual pull-tab paytable displays different prizes and ticket quantities to the player for the three different system driven Game Events supported by watermarked electronic pull-tab games.

More specifically, at block 510 the watermarked winning virtual pull-tab ticket quantity and the associated prize(s) for each watermarked winning virtual pull-tab ticket that remains in the virtual pull-tab deck is provided.

At block 512, the standard winning virtual pull-tab ticket quantity and the associated prize(s) for each standard winning virtual pull-tab ticket that remains in the virtual pull-tab deck is provided.

By way of example and not of limitation, at block 514, the different paytables from blocks 510 and 512 are combined and presented as a single virtual pull-tab paytable.

Further, at decision diamond 516, the paytable may indicate when the system driven “auto-close” Game Event is enabled. In the illustrative embodiment, proceeds from the system driven auto-close Game Event are applied to a progressive jackpot as shown in block 518. Auto-close refers to having the prize value of all remaining unclaimed tickets in a virtual pull-tab deck being automatically closed, i.e., auto-closed, so the remaining virtual pull-tab ticket values are applied to a progressive prize. Thus, the virtual pull-tab Game Session can support a progressive jackpot.

The system driven auto-close Game Event may be selected by the operator for any game played at a particular venue. The system driven auto-close Game Event automatically replaces a finite game pool with a new pool when a trigger condition is met by the status of the existing finite game pool of virtual pull-tab tickets. When the system driven auto-close Game Event is turned “ON,” a deck may automatically close and be replaced by a new deck when the trigger condition is met. In certain embodiments, the system driven auto close Game Event is identified by the requesting gaming device so players know that auto-close is active. A notification may also be given to all active clients when a new deck is open.

In a first embodiment, the trigger condition for auto-close includes having exhausted all prizes exceeding a predetermined value for the virtual pull-tab deck. Thus, if all prizes over a game specific value are awarded, then the trigger condition is satisfied. The specific value of prizes that trigger auto-close may be set by the operator. The purpose of triggering auto-close when certain or all high value prizes have been pulled and/or awarded from a virtual pull-tab deck is that the game may no longer be desirable for players since only lower value prizes remain available in the virtual pull-tab deck.

In a second embodiment, the trigger condition for auto-close includes having a certain quantity of tickets dispensed from the virtual pull-tab deck or only a certain number of virtual pull-tab tickets remain in the deck. For example, the trigger condition may be set so that 75% (750 virtual pull-tab tickets) of a 1,000 virtual pull-tab ticket deck have been dispensed or only 25% (250 tickets) of the 1,000 virtual pull-tab ticket deck remain. The operator may set the precise quantity or percent of virtual pull-tab tickets dispensed or remaining that trigger the system driven auto-close Game Event.

In an illustrative operational embodiment, the deck generator randomly shuffles the entire deck. After the shuffle, the deck generator counts the shuffled deck to find the shuffled ticket index that contains the last ticket meeting the auto-close criteria. The system then knows that after the identified number of tickets has been handed out, the deck closes. This illustrative operational embodiment operates as a combination of the first and second embodiments described above.

In a third embodiment, the trigger condition for auto-close includes having a predetermined time period that triggers the system driven auto-close Game Event. By way of example and not of limitation, the predetermined time period is initiated after the first ticket is pulled from the virtual pull-tab deck and the system driven auto-close Game Event is executed after completing the predetermined time period. Again, the operator may define the parameters for the predetermined time period.

In a fourth embodiment, the trigger condition for the system driven auto-close Game Event includes exhausting the watermarked winning pull-tab tickets that remain in the virtual pull-tab deck. The basis for initiating the system driven auto-close Game Event may be associated with the value of remaining pull-tab tickets in the deck being too low to attract players.

In a fifth embodiment, the trigger condition for the system driven auto-close Game Event includes exhausting all or most of the standard winning virtual pull-tab tickets. The basis for initiating the system driven auto-close Game Event for exhausting all or most of the standard winning virtual pull-tab tickets may be associated with the value of remaining pull-tab tickets in the deck being too low to attract players.

In a sixth embodiment, the trigger condition for the system driven auto-close Game Event includes exhausting a predetermined value for the remaining virtual pull-tab tickets in the deck. Again, the value of the remaining pull-tab tickets in the deck may be too low to attract players; thus, the operator may elect to simply identity a threshold predetermined value for the remaining virtual pull-tab tickets, in which the predetermined value attracts players to the virtual pull-tab game(s).

In a seventh embodiment, the trigger condition for the system driven auto-close Game Event includes a combination of exhausting all or most of the watermarked winning virtual pull-tab tickets and exhausting a predetermined value for the remaining virtual pull-tab tickets in the deck. For example, if all watermarked winning virtual pull-tab tickets are exhausted and the predetermined value for the remaining virtual pull-tab tickets is below a game specific value, then the system driven auto-close Game Event is triggered. Thus, the system driven auto-close Game Event is triggered when certain or all high value prizes (i.e., prizes associated with watermarked winning virtual pull-tab tickets) have been pulled from the deck causing game play to be limited to lower value prizes, which is undesirable to players.

For each of the auto-close embodiments described above, the operator establishes the auto-close variables and parameters.

At block 520, the wagering system 102 generates a virtual pull-tab deck that includes at least three different types of virtual pull-tab tickets. In the illustrative embodiment, the virtual pull-tab deck generated by the wagering system 102 includes no-prize virtual pull-tab tickets, standard winning virtual pull-tab tickets each associated with a winning prize, and watermarked winning virtual pull-tab tickets each associated with a winning prize.

At block 522, a requesting gaming device receives one of the virtual pull-tab tickets from the wagering system 102. In some embodiments, a limited discrete number of gaming devices may be “in play,” i.e., actively engaged in the execution of a gaming instance. In these embodiments, requests for virtual pull-tab tickets from additional gaming devices in excess of a maximum number of “in play” gaming devices may be queued by the system until the number of gaming devices “in play” drops below the maximum number of “in play” gaming devices, i.e., a gaming device actively executing a game instance completes that game instance. By way of example and not of limitation, the requesting gaming device may receive a winning ticket and a non-winning ticket as is well known in the electronic pull-tab arts. In all embodiments, the received virtual pull-tab ticket is randomly selected from a desired virtual pull-tab deck.

Within the watermarked virtual pull-tab decks disclosed herein there are two types of electronic pull-tab that operate in a well-known manner, namely, the no-prize virtual pull-tab tickets and the standard winning virtual pull-tab tickets. The no-prize virtual pull-tab ticket does not award a prize and operates like a non-winning ticket. The standard winning virtual pull-tab ticket operates like a traditional winning electronic pull-tab ticket, in which the winning ticket prize is displayed on the requesting gaming device as denoted by a symbol sequence that is associated with a particular winning value corresponding to the paytable associated with the deck from which the standard winning virtual pull-tab ticket was selected.

Additionally, the watermarked virtual pull-tab deck includes an additional type of pull-tab ticket, namely, the watermarked virtual pull-tab ticket type. In the illustrative embodiment, the watermarked virtual pull-tab tickets operate differently from the traditional electronic pull-tab tickets because of the suspense generating multi-stage animation reveal of the winning value of the ticket.

By way of example and not of limitation, a watermarked winning pull-tab ticket must first be received by the requesting device. Then, like traditional pull-tab tickets, a player input Game Action must be received at the requesting device that causes the system driven Game Event of revealing the ticket outcome. And, like traditional pull-tab tickets, the revealed game symbols indicate a win value for the ticket. However, unlike traditional pull-tab tickets, the symbol sequence revealed is associated with a range of win values, instead of a single win value. At least one symbol includes an embedded watermark graphic enhancement that is unique to a single win value, but not readily identifiable by most human players. A further reveal animation then occurs that creates suspense and anticipation for the player, while the win value of the ticket is more clearly displayed, such as with a numerical indication.

At decision diamond 524, a determination is made if a watermarked virtual pull-tab ticket is received by the requesting gaming device. If a watermarked virtual pull-tab ticket is received by the requesting device, then the method proceeds to block 526 where the initial watermarked graphic animation associated with the watermarked virtual pull-tab ticket is displayed on the requesting gaming device. In the illustrative embodiments discussed below, the initial watermarked graphic animation includes the animated display of a winning symbol sequence that includes an embedded watermark graphic enhancement. In some embodiments, the embedded watermark graphic enhancement is a grid pattern overlaying a portion of one of the symbols in the symbol sequence. In some embodiments, the embedded watermark graphic enhancement is a fruit symbol overlaying a portion of one of the symbols in the symbol sequence. In other embodiments, the embedded watermark graphic enhancement is an additional and separate symbol from the symbol sequence.

The method 500 then proceeds to block 528, where an intermediate graphic presentation is displayed on the requesting gaming device. The intermediate graphic presentation creates suspense by prolonging the time between the initial reveal and the clear display of the ticket's win value. In some embodiments, this suspense is combined with an exciting element, such as a series of one or more animation elements, where each element results in an increase to the displayed win value, culminating in the full win value of the ticket.

The method 500 then proceeds to block 534, where a final win graphic is displayed on the requesting gaming device. The final graphic displays the full win value of the ticket, such as a numeric value equal to the full win value of the ticket.

After presentation of the final win graphic in block 534, the method 500 proceeds to decision diamond 536 where a player determination is made to continue game play of a game session by requesting the next electronic pull-tab ticket in the multi-tab deck or to terminate game play.

If in decision diamond 524 a watermarked virtual pull-tab ticket is not received, the method proceeds to decision diamond 530 where the requesting gaming device determines if a standard winning virtual pull-tab ticket has been received.

If a standard winning virtual pull-tab ticket has not been received at decision diamond 530, the method proceeds to block 532 where a no-value or no-prize virtual pull-tab ticket has been received. A no-value virtual pull-tab ticket has a zero value so no prize is awarded. The method 500 then proceeds to block 534 where a final graphic indicating that no prize was won from the ticket is displayed on the requesting device. After presentation of this final “losing” graphic, the method 500 proceeds to decision diamond 536 where a player determination is made to continue game play by requesting a next virtual pull-tab ticket from the virtual pull-tab deck or to terminate game play, which may include ending the game session by ceasing player interaction with and occupation of the gaming device.

If a standard winning virtual pull-tab ticket is received at decision diamond 530, the method proceeds to block 534 where a final win graphic is presented on the requesting device indicating the prize associated with the ticket that is awarded.

After the prize has been awarded at block 534, the method 500 proceeds to decision diamond 536 where a player determination is made to continue game play by requesting the next virtual pull-tab ticket from the virtual pull-tab deck or to end game play, which may include ending the game session by ceasing player interaction with and occupation of the gaming device.

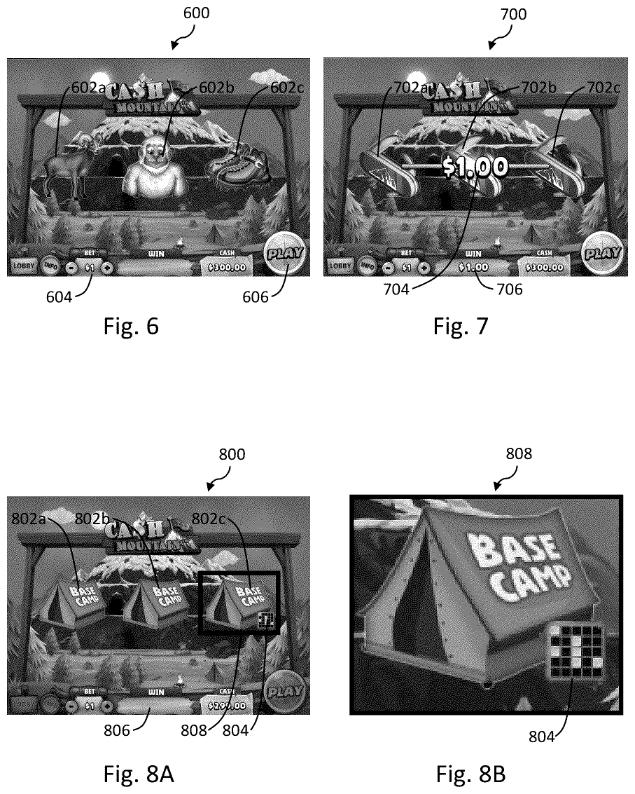

Referring to FIGS. 6 through 13 there are shown illustrative game play screenshots of a watermarked virtual pull-tab game. In FIG. 6 there is shown an illustrative start screen 600 displaying a losing sequence of symbols 602a, 602b, 602c, the wager amount per ticket 604, and the play button 606 that causes the system driven Game Event reveal of the purchased ticket when a player input Game Action taps, selects, or otherwise interacts with the play button 606.

While the illustrative embodiment presents a single 3-symbol row game display area, the term “row” is interchangeable with similar terms, such as “grid,” “column,” or “reel,” unless otherwise stated herein. Further, a grid may comprise a single row, a single column, multiple rows, and/or multiple columns, and is not limited to the illustrative 3-symbol row depicted in FIG. 6 and other figures herein. Further still, each row or column of a grid is not limited to three (3) game symbol display positions and may include more or fewer game symbol display positions. The size and number of symbols may vary according to the gaming engineering constraints such as display size, game mechanics, game play and other such engineering constraints.

In other embodiments, the game prizes may be presented to players using a variety of visual constructs. For example, a wheel constructed of wedge slices may be used to display the game prizes, where each slice may represent one or more prizes or tickets. One of skill in the art would recognize from this description that the presentation of prizes need not be limited to symbol arrays, grids or wheels, and any construct may be used to display the game prizes.

In the illustrative embodiment, the auto-close is “off.” The system driven auto-close Game Event may be selected by the operator. In some embodiments, the system driven auto-close Game Event automatically replaces a finite game pool with a new pool when all prizes exceeding a predetermined value for the deck have been exhausted and the game may no longer be desirable by players.

When the system driven auto-close Game Event is turned “ON,” a deck may automatically close and be replaced by a new deck when prizes over a game specific value set in the portal are gone. For example, a game may have 3 large value prizes and when the last prize is awarded, the deck may close, and a new deck may open. By way of example and not of limitation, the system driven auto-close Game Event is identified in the client game information when it is active, so players may know that it is active. A notification may also be given to all active clients when a new deck is open. This feature is attractive to players because they are always assured that there are always some valuable prizes remaining in a deck they may be playing.

When auto-close is enabled, the remaining prizes may be pooled into a progressive prize. Thus, in certain embodiments, proceeds from the auto-close may be applied to a progressive jackpot.

In FIG. 7 there is shown an illustrative final graphic 700 for a standard winning virtual pull-tab ticket displaying a winning sequence of symbols 702a, 702b, 702c, a clear numerical winning line value 704, and an express full win value 706 for the ticket. As discussed below, the paytable associated with this watermarked virtual pull-tab game includes only a single win value, $1.00, for the sequence of symbols 702a, 702b, 702c.

FIGS. 8A through 10 show a sequence of graphic animations for game play of a watermarked virtual pull-tab ticket. In FIG. 8A there is shown the result of a system driven winning Game Event where a winning sequence of symbols 802a, 802b, 802c that further include an embedded watermark graphic enhancement 804 are displayed to the player. The prize resulting from this illustrative system driven Game Event is the result of a virtual pull-tab ticket request generated by a requesting gaming device and received by the wagering system. As previously described, the virtual pull-tab ticket is transmitted from the wagering system to the requesting gaming device and the requesting gaming device receiving the virtual pull-tab ticket eventually displays the resulting prize.

Although FIG. 8A shows the initial graphic animation 800 for a winning watermarked virtual pull-tab ticket, there is a notable absence of a numerical win value in the ticket win value display box 806. The winning sequence of symbols 802a, 802b, 802c is associated with a range of win values, while the embedded watermark graphic enhancement 804 is associated with a single win value. Thus, a player may realize from the initial graphic animation 800 that the ticket is a winning ticket, but likely must view a detailed paytable to identify the precise value of the ticket from the grid pattern of the embedded watermark graphic enhancement 804.

FIG. 8B shows an enlarged view 808 of the game symbol 802c and the embedded watermark graphic enhancement 804. In this view 808, the particular arrangement of highlighted tiles and empty tiles in the embedded watermark graphic enhancement 804 grid are clearly visible. This arrangement of highlighted tiles and empty tiles is unique to the single winning value associated this ticket and this embedded watermark graphic enhancement 804 grid, i.e. no other watermark grid arrangement is associated with the winning value of this ticket.

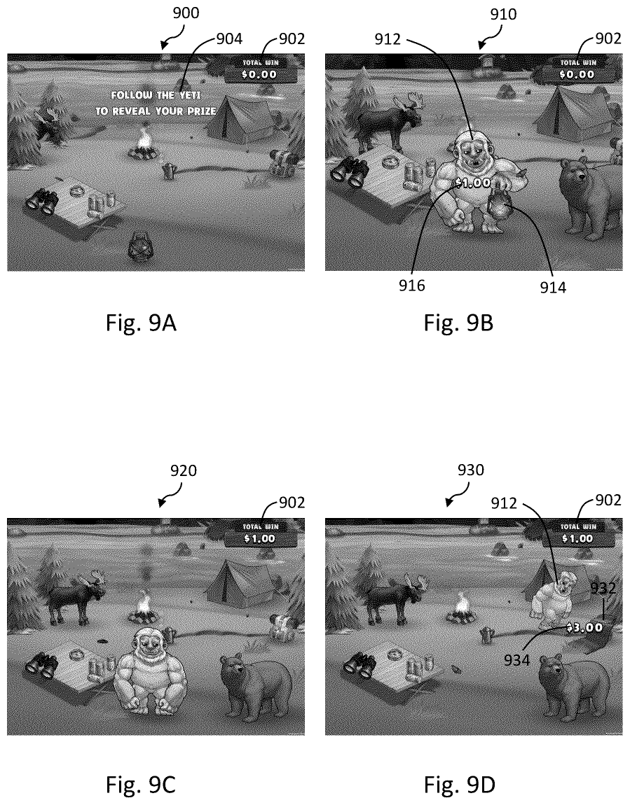

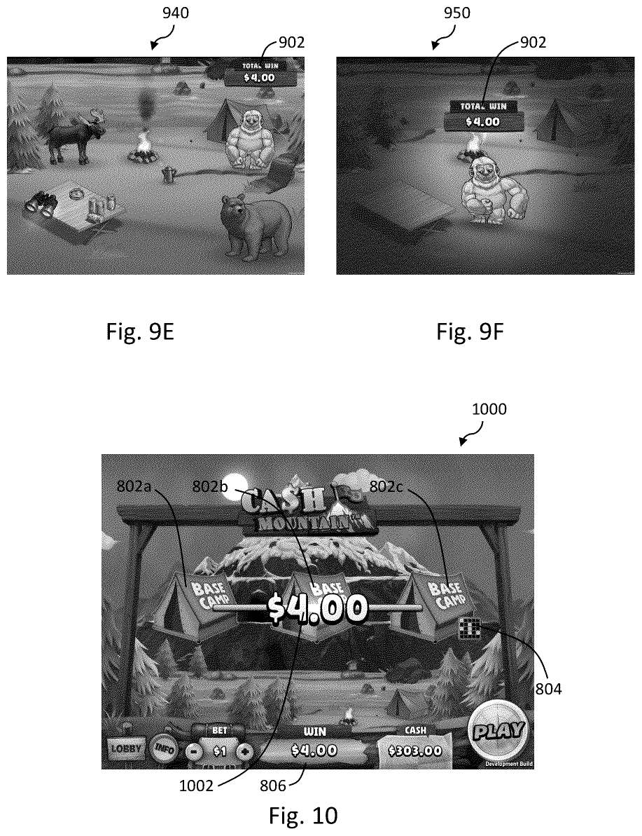

FIGS. 9A through 9F show a series of screenshots from an intermediate graphic animation, embodied as a perceived pick bonus, although no bonus is awarded associated with this perceived pick bonus as the outcome of the ticket is pre-determined as indicated by the embedded watermark graphic enhancement. In FIG. 9A the screen view 900 has zoomed-in on a background campsite graphic from the initial graphic animation 800 and displayed a total win counter 902 for the perceived pick bonus animation. The screen view 900 also displays an explanation 904 of the intermediate graphic animation, instructing the player that a “yeti” will reveal the full win value of the ticket.

In FIG. 9B the screen view 910 now includes the yeti 912, which has “picked” an item 914 from the campsite. When the yeti 912 “picks” the lantern item 914 an additional graphic appears in the intermediate animation indicating a win value 916 attributed to the lantern item 914.

In FIG. 9C the screen view 920 shows a tally animation where the win value attributed to the lantern item pick from FIG. 9B is recorded in the total win counter 902.

In FIG. 9D the intermediate graphic animation continues with a screen view 930 of a second pick animation. In this screen view 930 the total win counter 902 continues to display the win amount accumulated from the previous lantern item pick while the yeti 912 opens a backpack item 932 to reveal an additional win value 934.

In FIG. 9E the screen view 940 shows a second tally animation where the win value attributed to the backpack item pick from FIG. 9D is recorded in the total win counter 902 as an addition to the previously accumulated win value(s). Thus, the total win counter 902 shows the current accumulated win total from all displayed pick animations.

FIG. 9F shows a screen view 950 of a final celebration indicating the end of the intermediate animation and the accumulated full win value for the ticket in the total win counter 902.

FIG. 10 shows a screen shot view 1000 of the final graphic animation for the illustrative watermarked virtual pull-tab ticket. In the illustrative final graphic animation, the winning symbol sequence 802a, 802b, 802c is shown again with the embedded watermark graphic enhancement 804. However, the final graphic animation further includes a numeric representation 1002 of the full win value for the ticket overlaid on the symbol sequence so that the player does not have to refer to the paytable to determine the full win value associated with the embedded watermark graphic enhancement. Additionally, the full win value is presented in the ticket win value display box 806.

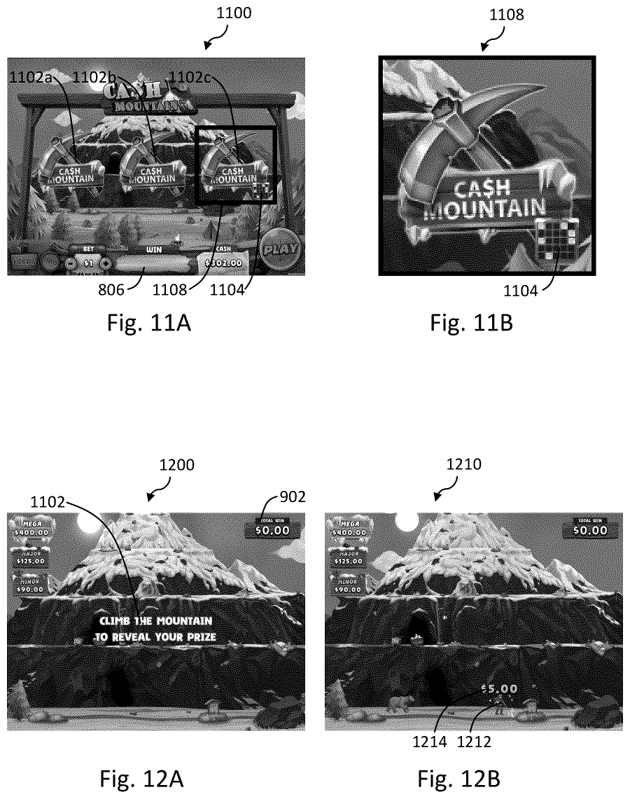

Referring now to FIGS. 11 through 13 show another sequence of graphic animations for game play of a watermarked virtual pull-tab ticket. In FIG. 11A there is shown a winning sequence of symbols 1102a, 1102b, 1102c that further include an embedded watermark graphic enhancement 1104. Although FIG. 11A shows the initial graphic animation 1100 for a winning watermarked virtual pull-tab ticket, there is a notable absence of a numerical win value in the ticket win value display box 806. The winning sequence of symbols 1102a, 1102b, 1102c is associated with a range of win values, while the embedded watermark graphic enhancement 1104 is associated with a single win value. Thus, a player may realize from the initial graphic animation 1100 that the ticket is a winning ticket, but likely must view a detailed paytable to identify the precise value of the ticket from the grid pattern of the embedded watermark graphic enhancement 1104.

FIG. 11B shows an enlarged view 1108 of the game symbol 1102c and the embedded watermark graphic enhancement 1104. In this view 1108, the particular arrangement of highlighted tiles and empty tiles in the embedded watermark graphic enhancement 1104 grid are clearly visible. This arrangement of highlighted tiles and empty tiles is unique to the single winning value associated this ticket and this embedded watermark graphic enhancement 1104 grid, i.e. no other watermark grid arrangement is associated with the winning value of this ticket.

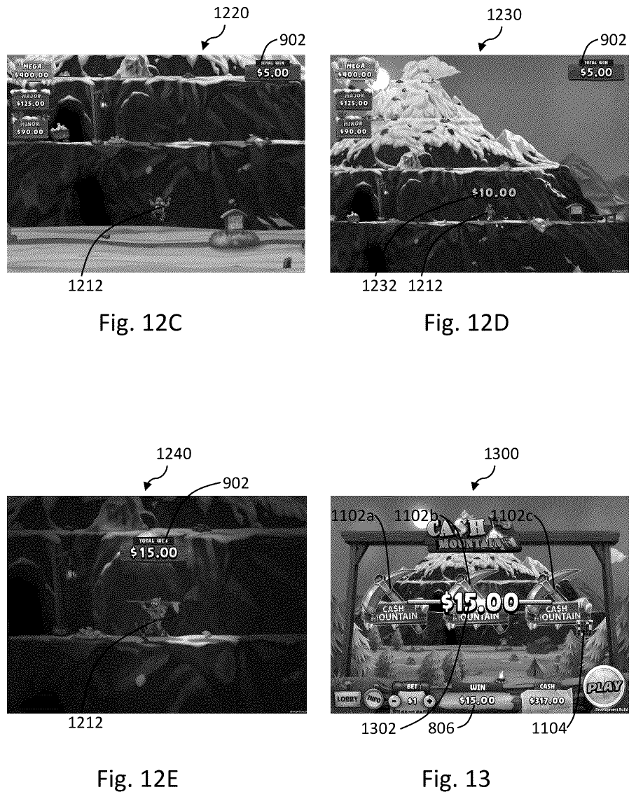

FIGS. 12A through 12E show a series of screenshots from an intermediate graphic animation, embodied as an extended rollup, although the outcome of the ticket is pre-determined as indicated by the embedded watermark graphic enhancement. In FIG. 12A the screen view 1200 has zoomed-in on a background mountain graphic from the initial graphic animation 1100 and displayed a total win counter 902 for the rollup animation. The screen view 1100 also displays an explanation 1102 of the intermediate graphic animation, instructing the player that climbing the mountain will reveal the full win value of the ticket.

In FIG. 12B the screen view 1210 now includes the mountain climber 1212, which has appeared at the base of the mountain. When the mountain climber 1212 is displayed an additional graphic appears in the intermediate animation indicating a win value 1214 attributed to the mountain climber's appearance.

In FIG. 12C the screen view 1220 shows the mountain climber 1212 ascending from a starting position at the base of the mountain towards a first tier of the mountain. Additionally, the screen view 1220 shows the win value 1214 attributed to the appearance of the mountain climber recorded in the total win counter 902.

In FIG. 12D the screen view 1230 shows the mountain climber 1212 having achieved the first tier of the mountain and earned an additional win value 1232.

In FIG. 12E the screen view 1240 shows a final celebration of the mountain climber 1212 indicating the end of the intermediate animation and the accumulated full win value for the ticket in the total win counter 902.

FIG. 13 shows a screen shot view 1300 of the final graphic animation for the illustrative watermarked virtual pull-tab ticket. In the illustrative final graphic animation the winning symbol sequence 1102a, 1102b, 1102c is shown again with the embedded watermark graphic enhancement 1104. However, the final graphic animation further includes a numeric representation 1302 of the full win value for the ticket overlaid on the symbol sequence so that the player does not have to refer to the paytable to determine the full win value associated with the embedded watermark graphic enhancement. Additionally, the full win value is presented in the ticket win value display box 806.

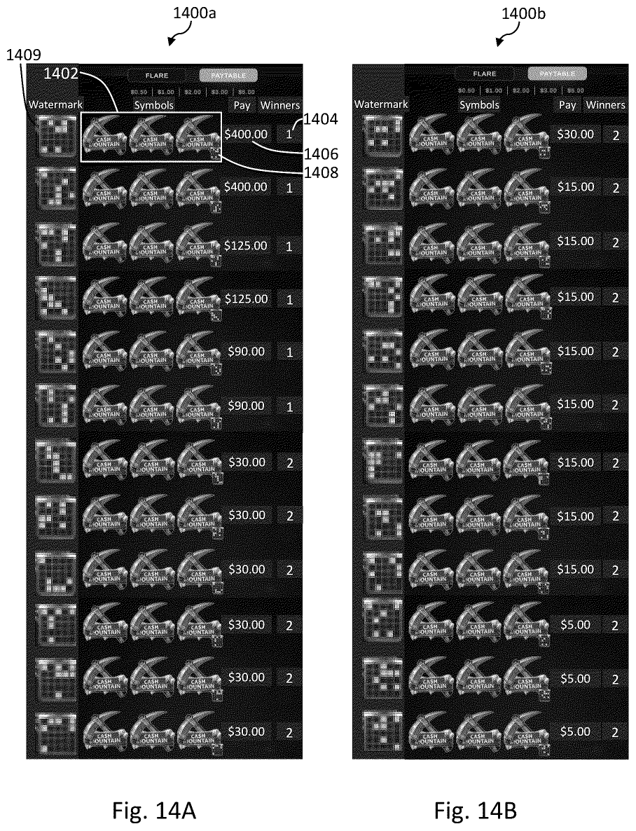

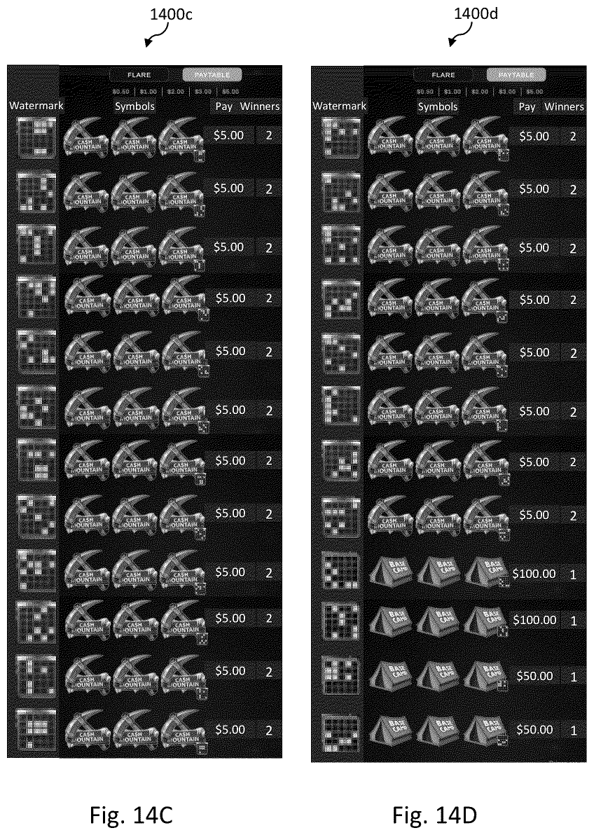

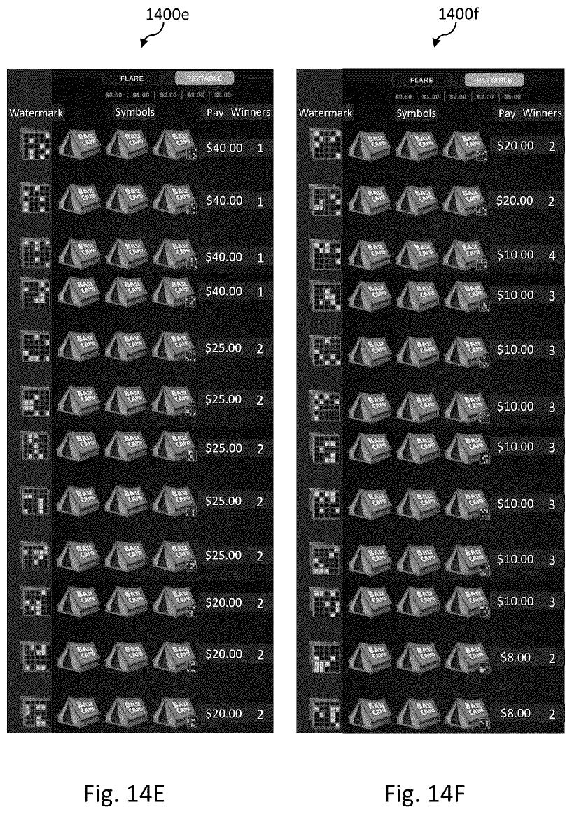

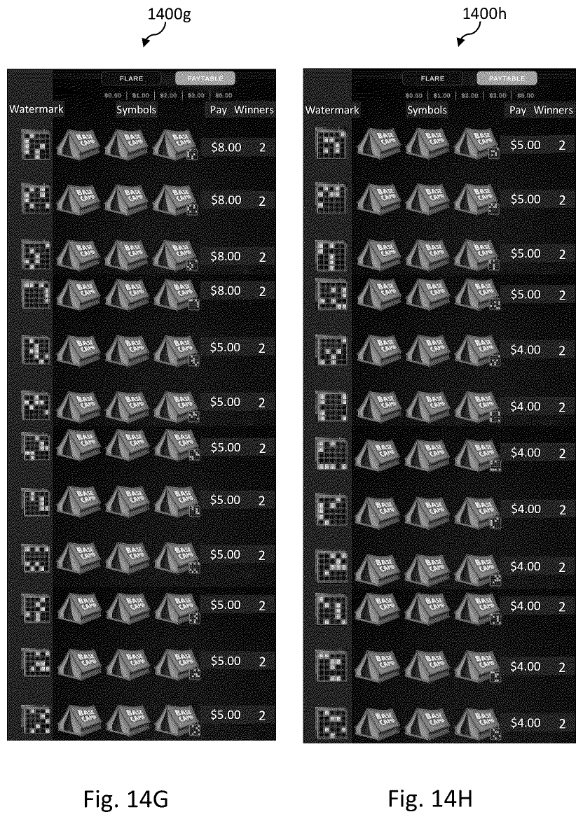

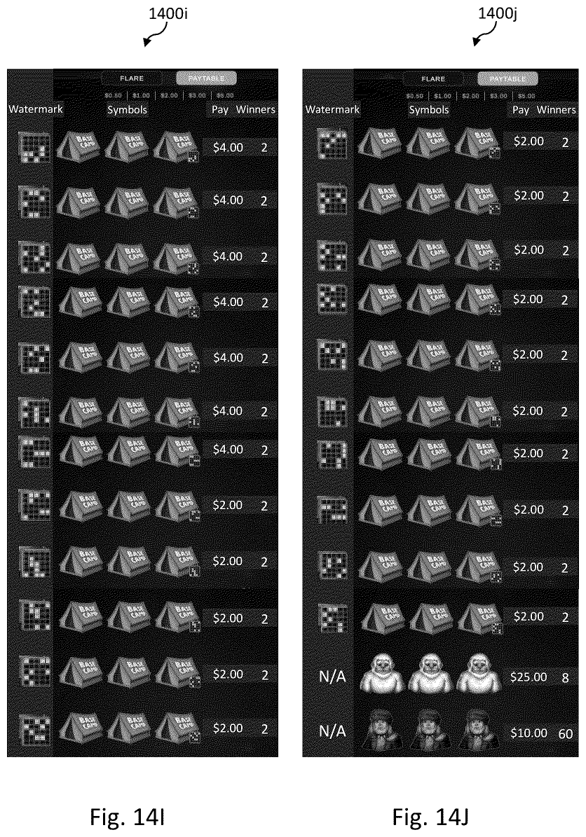

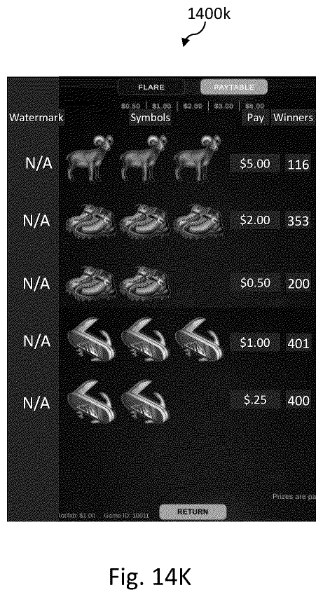

With reference now to FIGS. 14A through 14K illustrative screenshots 1400a through 1400k of a composite single watermarked virtual pull-tab ticket paytable are shown. The watermarked and standard prizes are listed in a “paytable” menu view in the illustrative watermarked virtual pull-tab game display. The illustrative screen shots 1400a through 1400k include depictions of symbol sequences 1402, the number of tickets 1404 having the symbol sequence 1402 in the illustrative virtual pull-tab deck, and the full win value 1406 of the prize associated with each of the pull-tab tickets. The available prizes awarded for each ticket are associated with a wager of $1, which is indicated in each of FIGS. 14A through 14K. Each watermarked symbol sequence 1402 further includes the watermark graphic enhancement 1408 embedded in certain symbol(s) that uniquely identifies the win value of the symbol sequence. For the purpose of clarity, the embedded watermark graphic enhancement 1408 for each watermarked symbol sequence is reproduced in an enlarged format 1409. This enlarged format 1409 clearly shows that each grid pattern is unique, although some grid patterns are associated with the same win value as one or more other grid patterns. In these examples, while multiple grid patterns may indicate the same win value, each grid pattern may be associated with a unique intermediate graphic animation, such as the order or identity of objects picked by the yeti 916 or the climbing path taken by the climber 1212.

In FIGS. 14A through 14J, the illustrative screenshots 1400a through 1400j of the watermarked virtual pull-tab ticket paytable show the number and type of watermarked virtual pull-tab tickets contained in an illustrative deck. More particularly, in illustrative screenshots 1400a through 1400j there are a total of two watermarked virtual pull-tab tickets with a win value of $400.00, each with a unique grid pattern; two watermarked virtual pull-tab tickets with a win value of $125.00, each with a unique grid pattern; two watermarked virtual pull-tab tickets with a win value of $100.00, each with a unique grid pattern; two watermarked virtual pull-tab tickets with a win value of $90.00, each with a unique grid pattern; two watermarked virtual pull-tab tickets with a win value of $50.00, each with a unique grid pattern; four watermarked virtual pull-tab tickets with a win value of $40.00, each with a unique grid pattern; fourteen watermarked virtual pull-tab tickets with a win value of $30.00, with seven unique grid patterns each associated with two watermarked virtual pull-tab tickets; ten watermarked virtual pull-tab tickets with a win value of $25.00, with five unique grid patterns each associated with two watermarked virtual pull-tab tickets; ten watermarked virtual pull-tab tickets with a win value of $20.00, with five unique grid patterns each associated with two watermarked virtual pull-tab tickets; sixteen watermarked virtual pull-tab tickets with a win value of $15.00, with eight unique grid patterns each associated with two watermarked virtual pull-tab tickets; twenty-five watermarked virtual pull-tab tickets with a win value of $10.00, with eight unique grid patterns each associated with three or four watermarked virtual pull-tab tickets; twelve watermarked virtual pull-tab tickets with a win value of $8.00, with six unique grid patterns each associated with two watermarked virtual pull-tab tickets; seventy-four watermarked virtual pull-tab tickets with a win value of $5.00, with thirty-seven unique grid patterns each associated with two watermarked virtual pull-tab tickets; thirty watermarked virtual pull-tab tickets with a win value of $4.00, with fifteen unique grid patterns each associated with two watermarked virtual pull-tab tickets; and thirty watermarked virtual pull-tab tickets with a win value of $2.00, with fifteen unique grid patterns each associated with two watermarked virtual pull-tab tickets.

Additionally, in FIGS. 14J and 14K, the illustrative screenshots 1400j and 1400k of the watermarked virtual pull-tab ticket paytable show the number and type of standard winning virtual pull-tab tickets in the illustrative deck. In illustrative screenshots 1400j and 1400k there are a total of eight standard winning virtual pull-tab tickets with a win value of $25.00, each having NO grid pattern; sixty standard winning virtual pull-tab tickets with a win value of $10.00, each having NO grid pattern; one-hundred sixteen standard winning virtual pull-tab tickets with a win value of $5.00, each having NO grid pattern; three-hundred fifty-three standard winning virtual pull-tab tickets with a win value of $2.00, each having NO grid pattern; two-hundred standard winning virtual pull-tab tickets with a win value of $0.50, each having NO grid pattern; four-hundred one standard winning virtual pull-tab tickets with a win value of $1.00, each having NO grid pattern; and four-hundred standard winning virtual pull-tab tickets with a win value of $0.25, each having NO grid pattern.

In some embodiments, the paytable displays only the remaining prizes in a particular deck after one or more winning tickets have been distributed and played. This list of remaining winning prizes enables the player to assess whether the prize values are attractive enough to support continued game play.

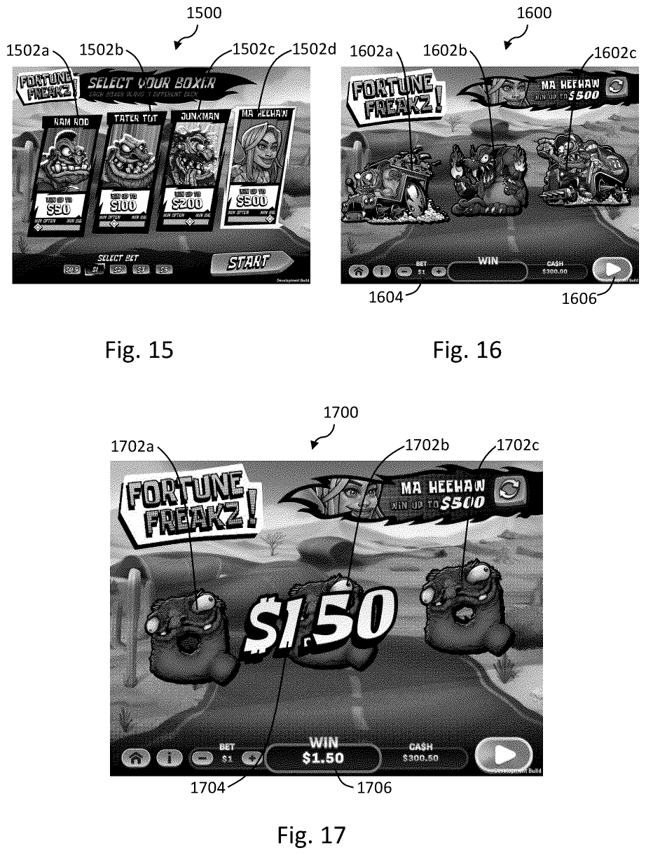

With reference now to FIGS. 15 through 20B there are shown illustrative game play screenshots of a watermarked virtual pull-tab game. In FIG. 15 there is shown an illustrative character selection screen 1500 displaying character icons 1502a, 1502b, 1502c, and 1502d available for selection by the player. In this embodiment, each character icon 1502a, 1502b, 1502c, and 1502d is associated with a different virtual pull-tab deck, thus selection of a character 1502 is equivalent to selection of a particular virtual pull-tab deck. Further, in this illustrative embodiment, the virtual pull-tab deck associated with the character Ma Heehaw 1502d is selected. In some embodiments, the character 1502 is chosen with a player input Game Action, such as tapping, selecting, or otherwise interacting with a desired character icon 1502.

In FIG. 16 there is shown an illustrative start screen 1600 displaying a losing sequence of symbols 1602a, 1602b, 1602c, the wager amount per ticket 1604, and the play button 1606 that causes the system driven Game Event reveal of the purchased ticket when a player input Game Action taps, selects, or otherwise interacts with the play button 1606.

While the illustrative embodiment presents a single 3-symbol row game display area, the term “row” is interchangeable with similar terms, such as “grid,” “column,” or “reel,” unless otherwise stated herein. Further, a grid may comprise a single row, a single column, multiple rows, and/or multiple columns, and is not limited to the illustrative 3-symbol row depicted in FIG. 6 and other figures herein. Further still, each row or column of a grid is not limited to three (3) game symbol display positions and may include more or fewer game symbol display positions. The size and number of symbols may vary according to the gaming engineering constraints such as display size, game mechanics, game play and other such engineering constraints.

In other embodiments, the game prizes may be presented to players using a variety of visual constructs. For example, a wheel constructed of wedge slices may be used to display the game prizes, where each slice may represent one or more prizes or tickets. One of skill in the art would recognize from this description that the presentation of prizes need not be limited to symbol arrays, grids or wheels, and any construct may be used to display the game prizes.

In the illustrative embodiment, the auto-close is “off.” The system driven auto-close Game Event may be selected by the operator. In some embodiments, the system driven auto-close Game Event automatically replaces a finite game pool with a new pool when all prizes exceeding a predetermined value for the deck have been exhausted and the game may no longer be desirable by players.

When the system driven auto-close Game Event is turned “ON,” a deck may automatically close and be replaced by a new deck when prizes over a game specific value set in the portal are gone. For example, a game may have 3 large value prizes and when the last prize is awarded, the deck may close, and a new deck may open. By way of example and not of limitation, the system driven auto-close Game Event is identified in the client game information when it is active, so players may know that it is active. A notification may also be given to all active clients when a new deck is open. This feature is attractive to players because they are always assured that there are always some valuable prizes remaining in a deck they may be playing.

When auto-close is enabled, the remaining prizes may be pooled into a progressive prize. Thus, in certain embodiments, proceeds from the auto-close may be applied to a progressive jackpot.

In FIG. 17 there is shown an illustrative final graphic 1700 for a standard winning virtual pull-tab ticket displaying a winning sequence of symbols 1702a, 1702b, 1702c, a clear numerical winning value 1704, and a separate full win value 1706 for the ticket. As discussed below, the paytable associated with this watermarked virtual pull-tab game includes only a single win value, $1.50, for the sequence of symbols 1702a, 1702b, 1702c.

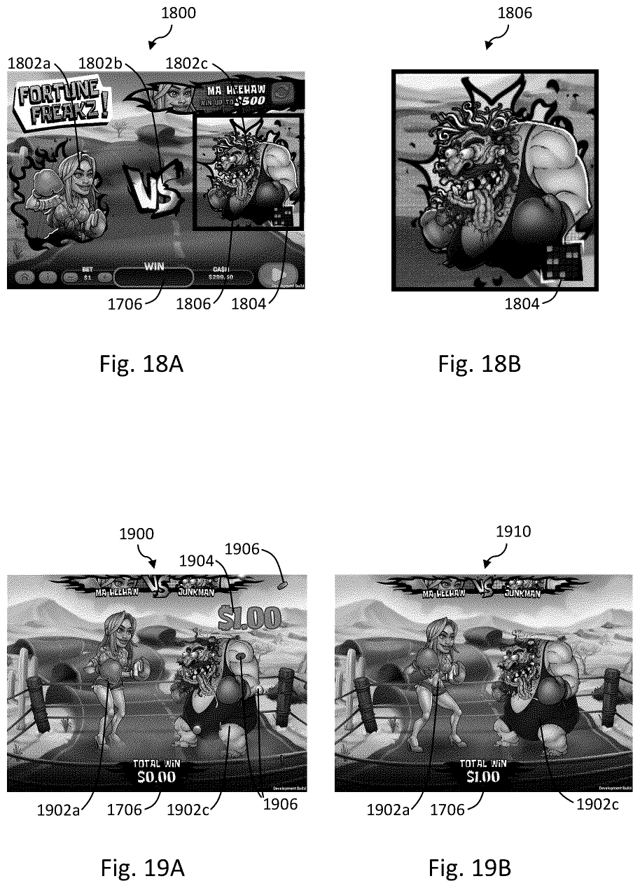

FIGS. 18A through 20B show a sequence of graphic animations for game play of a watermarked virtual pull-tab ticket. In FIG. 18A there is shown the result of a winning system driven Game Event where a winning sequence of symbols 1802a, 1802b, 1802c that further include an embedded watermark graphic enhancement 1804 are displayed to the player. The prize resulting from this illustrative system driven Game Event is the result of a virtual pull-tab ticket request generated by a requesting gaming device and received by the wagering system. As previously described, the virtual pull-tab ticket is transmitted from the wagering system to the requesting gaming device and the requesting gaming device receiving the virtual pull-tab ticket eventually displays the resulting prize.

Although FIG. 18A shows the initial graphic animation 1800 for a winning watermarked virtual pull-tab ticket, there is a notable absence of a numerical win value in the ticket win value display box 1706. The winning sequence of symbols 1802a, 1802b, 1802c is associated with a range of win values, while the embedded watermark graphic enhancement 1804 is associated with a single win value. Thus, a player may realize from the initial graphic animation 1800 that the ticket is a winning ticket, but likely must view a detailed paytable to identify the precise value of the ticket from the grid pattern of the embedded watermark graphic enhancement 1804.

FIG. 18B shows an enlarged view 1806 of the game symbol 1802c and the embedded watermark graphic enhancement 1804. In this view 1806, the particular arrangement of highlighted tiles and empty tiles in the embedded watermark graphic enhancement 1804 grid are clearly visible. This arrangement of highlighted tiles and empty tiles is unique to the single winning value associated this ticket and this embedded watermark graphic enhancement 1804 grid, i.e. no other watermark grid arrangement is associated with the winning value of this ticket.

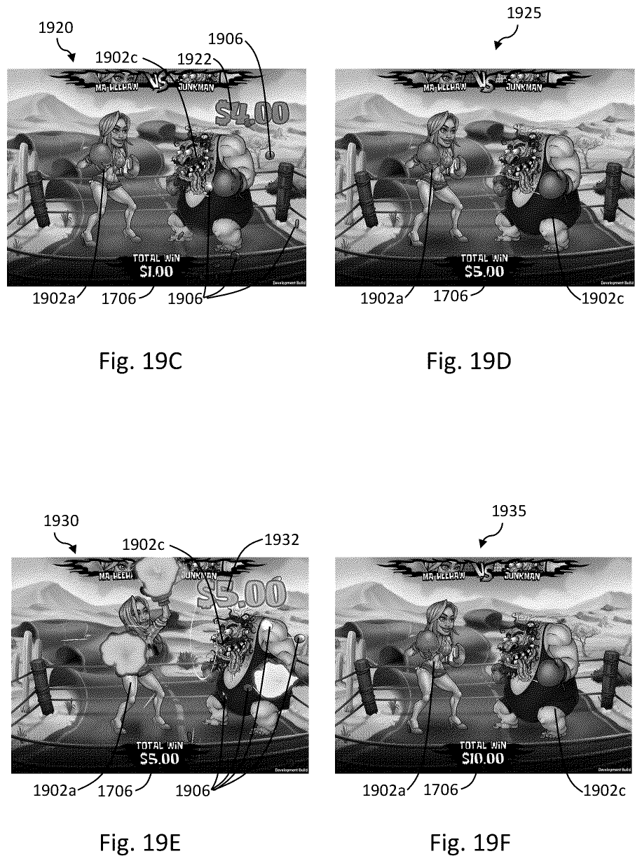

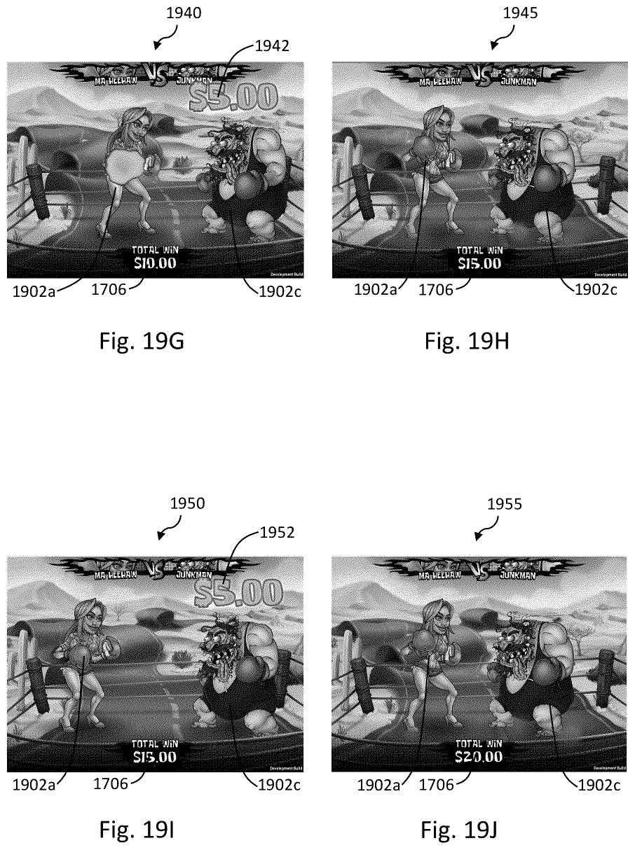

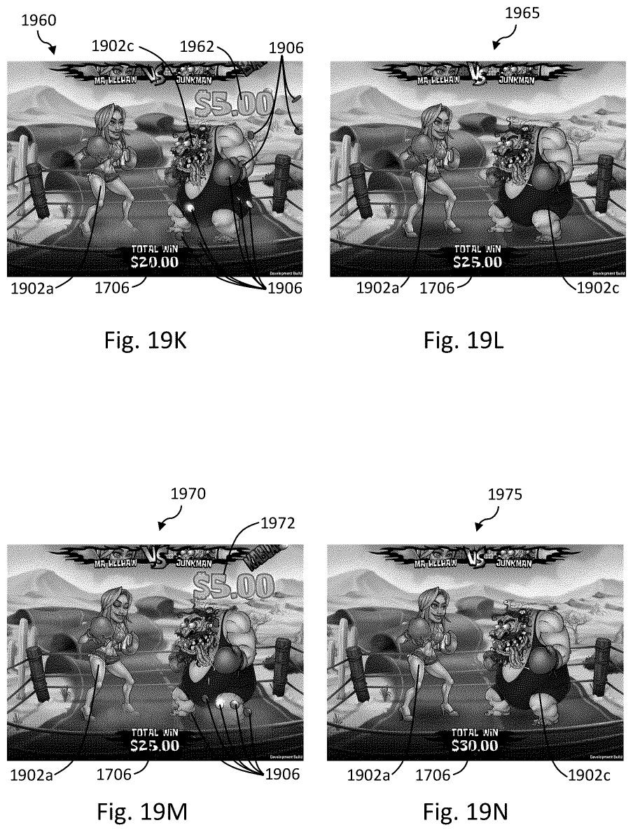

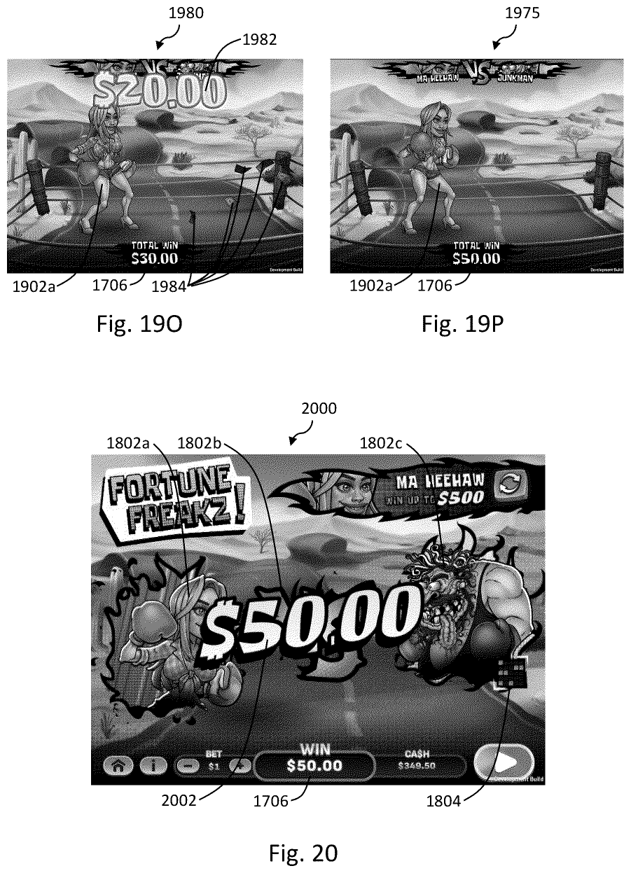

FIGS. 19A through 19P show a series of screenshots from an intermediate graphic animation, embodied as an extended fight rollup bonus, although no bonus is awarded associated with this perceived bonus animation as the outcome of the ticket is pre-determined as indicated by the embedded watermark graphic enhancement. In FIG. 19A the screen view 1900 has been cleared of game symbols to instead display the two fighting characters 1902a and 1902c shown by the game symbols 1802a and 1802c from the initial graphic animation 1800, while continuing to display the total win counter 1706 for the ticket and now the perceived fight bonus animation. In some embodiments, this first screen view 1900 of the intermediate graphic animation a $1.00 symbol 1904 has been displayed to signify that beginning the fight animation has awarded the player a partial prize of $1.00. In some embodiments, this first screen view 1900 of the intermediate graphic animation a $1.00 symbol 1904 has been displayed after an animation of the player's Ma Heehaw character 1902a has landed a strike, punch, or otherwise hit the opponent Junkman character 1902c. Such a fight animation may cause additional animations to occur, such as coins 1906 associated with the $1.00 symbol 1904 being ejected from the Junkman character 1902c.

In FIG. 19B the screen view 1910 shows a tally animation where the win value attributed to the strike landed by the player's Ma Heehaw character 1902a, the $1.00 symbol 1904, and the coins 1906 ejected from the opponent Junkman character 1902c from FIG. 19A is recorded in the total win counter 1706, which has increased from the initial $0.00 reading to now include a running cumulative total of $1.00.Although, the Ma Heehaw character was chosen before placing the wager, which is a pre-purchase selection, the selection could also have been performed by the game by randomly selecting the character.

In FIG. 19C the screen view 1920 shows a second stage of the intermediate graphic animation where a $4.00 symbol 1922 has been displayed after a second animation of the player's Ma Heehaw character 1902a landing a strike, punch, or otherwise hitting the opponent Junkman character 1902c. In the illustrative animation, coins 1906 associated with the $4.00 symbol 1922 have again been ejected from the opponent Junkman character 1902c as a result of the player's Ma Heehaw character 1902a striking the opponent Junkman character 1902c. During this second stage of the intermediate graphic animation, the partial win value associated with the $4.00 symbol 1922 has not yet been recorded in the total win counter 1706, which continues to display only the previously accumulated win value during the intermediate graphic animation.

In FIG. 19D the screen view 25 shows a tally animation where the win value attributed to the strike landed by the player's Ma Heehaw character 1902a, the $4.00 symbol 1922, and the coins 1906 ejected from the opponent Junkman character 1902c from FIG. 19C is recorded in the total win counter 1706, which has increased from the previous $1.00 reading to now include a running cumulative total of $5.00.

In FIG. 19E the screen view 1930 shows a third stage of the intermediate graphic animation where a $5.00 symbol 1932 has been displayed after a third animation of the player's Ma Heehaw character 1902a landing a strike, punch, or otherwise hitting the opponent Junkman character 1902c. In the illustrative animation, coins 1906 associated with the $5.00 symbol 1932 have again been ejected from the opponent Junkman character 1902c as a result of the player's Ma Heehaw character 1902a striking the opponent Junkman character 1902c. Additionally, both the player's Ma Heehaw character 1902a and the opponent Junkman character 1902c are shown with highlighted gloves to further animate their respective striking actions. During this third stage of the intermediate graphic animation, the partial win value associated with the $5.00 symbol 1932 has not yet been recorded in the total win counter 1706, which displays only the previously accumulated win value from the first and second stages of the intermediate graphic animation.

In FIG. 19F the screen view 1935 shows a tally animation where the win value attributed to the strike landed by the player's Ma Heehaw character 1902a, the $5.00 symbol 1932, and the coins 1906 ejected from the opponent Junkman character 1902c from FIG. 19E is recorded in the total win counter 1706, which has increased from the previous $5.00 reading to now include a running cumulative total of $10.00.

In FIG. 19G the screen view 1940 shows a fourth stage of the intermediate graphic animation where another $5.00 symbol 1942 has been displayed after a fourth animation of the player's Ma Heehaw character 1902a landing a strike, punch, or otherwise hitting the opponent Junkman character 1902c. In the illustrative animation, no coins associated with the $5.00 symbol 1942 are shown as having been ejected from the opponent Junkman character 1902c as a result of the player's Ma Heehaw character 1902a striking the opponent Junkman character 1902c. However, in some embodiments, additional animations, such as the ejection of coins or other symbols are shown and associated with the player's Ma Heehaw character 1902a striking the opponent Junkman character 1902c. During this fourth stage of the intermediate graphic animation, the partial win value associated with the $5.00 symbol 1942 has not yet been recorded in the total win counter 1706, which continues to display only the previously accumulated win value from the first, second, and third stages of the intermediate graphic animation.

In FIG. 19H the screen view 1945 shows a tally animation where the win value attributed to the strike landed by the player's Ma Heehaw character 1902a and the $5.00 symbol 1942 from FIG. 19G is recorded in the total win counter 1706, which has increased from the previous $10.00 reading to now include a running cumulative total of $15.00.

In FIG. 191 the screen view 1950 shows a fifth stage of the intermediate graphic animation where yet another $5.00 symbol 1952 has been displayed after a fifth animation of the player's Ma Heehaw character 1902a landing a strike, punch, or otherwise hitting the opponent Junkman character 1902c. In the illustrative animation, no coins associated with the $5.00 symbol 1952 are shown as having been ejected from the opponent Junkman character 1902c as a result of the player's Ma Heehaw character 1902a striking the opponent Junkman character 1902c. However, in some embodiments, additional animations, such as the ejection of coins or other symbols are shown and associated with the player's Ma Heehaw character 1902a striking the opponent Junkman character 1902c. During this fifth stage of the intermediate graphic animation, the partial win value associated with the $5.00 symbol 1952 has not yet been recorded in the total win counter 1706, which continues to display only the previously accumulated win value from the first, second, third, and fourth stages of the intermediate graphic animation.

In FIG. 19J the screen view 1955 shows a tally animation where the win value attributed to the strike landed by the player's Ma Heehaw character 1902a and the $5.00 symbol 1952 from FIG. 191 is recorded in the total win counter 1706, which has increased from the previous $15.00 reading to now include a running cumulative total of $20.00.

In FIG. 19K the screen view 1960 shows a sixth stage of the intermediate graphic animation where still another $5.00 symbol 1962 has been displayed after a sixth animation of the player's Ma Heehaw character 1902a landing a strike, punch, or otherwise hitting the opponent Junkman character 1902c. In the illustrative animation, coins 1906 associated with the $5.00 symbol 1962 have once again been ejected from the opponent Junkman character 1902c as a result of the player's Ma Heehaw character 1902a striking the opponent Junkman character 1902c. During this sixth stage of the intermediate graphic animation, the partial win value associated with the $5.00 symbol 1962 has not yet been recorded in the total win counter 1706, which continues to display only the previously accumulated win value from the first, second, third, fourth, and fifth stages of the intermediate graphic animation.

In FIG. 19L the screen view 1965 shows a tally animation where the win value attributed to the strike landed by the player's Ma Heehaw character 1902a, the $5.00 symbol 1962, and the coins 1906 ejected from the opponent Junkman character 1902c from FIG. 19K is recorded in the total win counter 1706, which has increased from the previous $20.00 reading to now include a running cumulative total of $25.00.

In FIG. 19M the screen view 1970 shows a seventh stage of the intermediate graphic animation where even another $5.00 symbol 1972 has been displayed after a seventh animation of the player's Ma Heehaw character 1902a landing a strike, punch, or otherwise hitting the opponent Junkman character 1902c. In the illustrative animation, coins 1906 associated with the $5.00 symbol 1972 have once again been ejected from the opponent Junkman character 1902c as a result of the player's Ma Heehaw character 1902a striking the opponent Junkman character 1902c. During this seventh stage of the intermediate graphic animation, the partial win value associated with the $5.00 symbol 1972 has not yet been recorded in the total win counter 1706, which continues to display only the previously accumulated win value from the first, second, third, fourth, fifth, and sixth stages of the intermediate graphic animation.

In FIG. 19N the screen view 1975 shows a tally animation where the win value attributed to the strike landed by the player's Ma Heehaw character 1902a, the $5.00 symbol 1972, and the coins 1906 ejected from the opponent Junkman character 1902c from FIG. 19M is recorded in the total win counter 1706, which has increased from the previous $25.00 reading to now include a running cumulative total of $30.00.

In FIG. 19O the screen view 1980 shows an eighth stage of the intermediate graphic animation where a $20.00 symbol 1982 has been displayed after an eighth animation of the player's Ma Heehaw character 1902a landing a strike, punch, or otherwise hitting the opponent Junkman character. In the illustrative animation, dollar bills 1984 associated with the $20.00 symbol 1982 have been ejected from the defeated opponent Junkman character as a result of the player's Ma Heehaw character 1902a striking the opponent Junkman character. During this eighth stage of the intermediate graphic animation, the partial win value associated with the $20.00 symbol 1982 has not yet been recorded in the total win counter 1706, which continues to display only the previously accumulated win value from the first, second, third, fourth, fifth, sixth, and seventh stages of the intermediate graphic animation. Additionally, the opponent Junkman character has been removed, disappeared, or caused to leave the animation as a result of the player's Ma Heehaw character 1902a striking (or successively striking) the opponent Junkman character.

In FIG. 19P the screen view 1985 shows a tally animation where the win value attributed to the strike landed by the player's Ma Heehaw character 1902a, the $20.00 symbol 1982, and the dollar bills 1984 ejected from the opponent Junkman character from FIG. 19O is recorded in the total win counter 1706, which has increased from the previous $30.00 reading to now include a final cumulative total of $50.00.

FIG. 20 shows a screen shot view 2000 of the final graphic animation for the illustrative watermarked virtual pull-tab ticket. In the illustrative final graphic animation, the winning symbol sequence 1802a, 1802b, 1802c is shown again with the embedded watermark graphic enhancement 1804. However, the final graphic animation further includes a numeric representation 2002 of the full win value for the ticket overlaid on the symbol sequence so that the player does not have to refer to the paytable to determine the full win value associated with the embedded watermark graphic enhancement. Additionally, the full win value is presented in the ticket win value display box 1706.

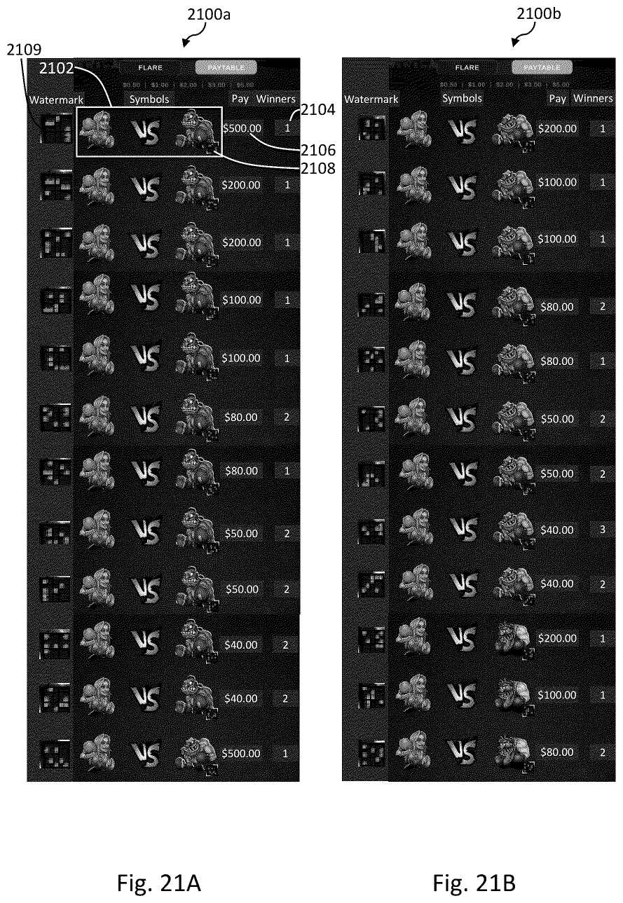

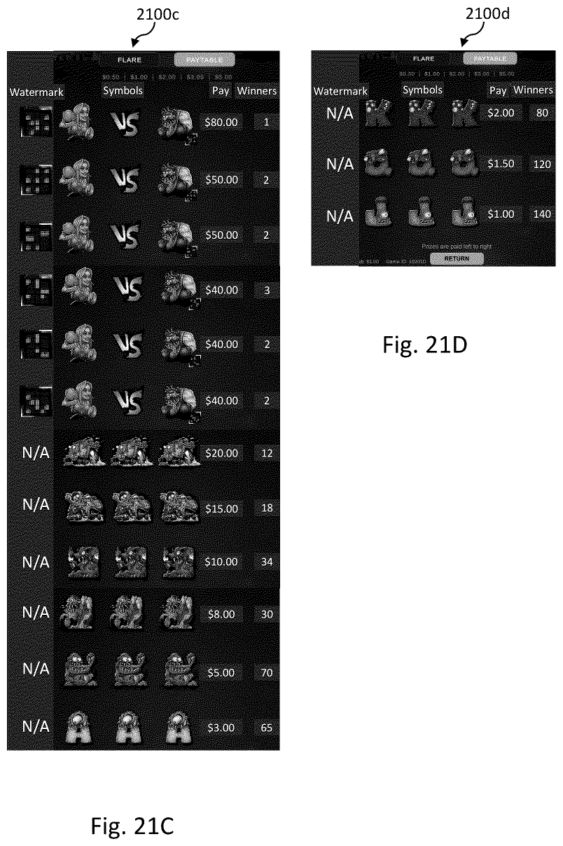

With reference now to FIGS. 21A through 21D illustrative screenshots 2100a through 2100d of a composite single watermarked virtual pull-tab ticket paytable are shown. The watermarked and standard prizes are listed in a “paytable” menu view in the illustrative watermarked virtual pull-tab game display. The illustrative screen shots 2100a through 2100d include depictions of symbol sequences 2102, the number of tickets 2104 having the symbol sequence 2102 in the illustrative virtual pull-tab deck, and the full win value 2106 of the prize associated with each of the pull-tab tickets. The available prizes awarded for each ticket are associated with a wager of $1, which is indicated in each of FIGS. 21A through 21D. Each watermarked symbol sequence 2102 further includes the watermark graphic enhancement 2108 embedded in certain symbol(s) that uniquely identifies the win value of the symbol sequence. For the purpose of clarity, the embedded watermark graphic enhancement 2108 for each watermarked symbol sequence is reproduced in an enlarged format 2109. This enlarged format 2109 clearly shows that each grid pattern is unique, although some grid patterns are associated with the same win value as one or more other grid patterns. In these examples, while multiple grid patterns may indicate the same win value, each grid pattern may be associated with a unique intermediate graphic animation, such as the length and type of fight animations, i.e. type and number of punches, landed by one character on the opposing character.

In FIGS. 21A through 21D, the illustrative screenshots 2100a through 2100d of the watermarked virtual pull-tab ticket paytable show the number and type of watermarked virtual pull-tab tickets contained in an illustrative deck. More particularly, in illustrative screenshots 2100a through 2100d there are a total of two watermarked virtual pull-tab tickets with a win value of $500.00, each with a unique grid pattern; four watermarked virtual pull-tab tickets with a win value of $200.00, each with a unique grid pattern; five watermarked virtual pull-tab tickets with a win value of $100.00, each with a unique grid pattern; nine watermarked virtual pull-tab tickets with a win value of $80.00, with six unique grid patterns each associated with one or two watermarked virtual pull-tab tickets; twelve watermarked virtual pull-tab tickets with a win value of $50.00, with six unique grid patterns each associated with two watermarked virtual pull-tab tickets; and sixteen watermarked virtual pull-tab tickets with a win value of $40.00, with seven unique grid patterns each associated with two or three watermarked virtual pull-tab tickets.

Additionally, in FIGS. 21C and 21D, the illustrative screenshots 2100c and 2100d of the watermarked virtual pull-tab ticket paytable show the number and type of standard winning virtual pull-tab tickets in the illustrative deck. In illustrative screenshots 2100c and 2100d there are a total of twelve standard winning virtual pull-tab tickets with a win value of $20.00, each having NO grid pattern; eighteen standard winning virtual pull-tab tickets with a win value of $15.00, each having NO grid pattern; thirty-four standard winning virtual pull-tab tickets with a win value of $10.00, each having NO grid pattern; thirty standard winning virtual pull-tab tickets with a win value of $8.00, each having NO grid pattern; seventy standard winning virtual pull-tab tickets with a win value of $5.00, each having NO grid pattern; and sixty-five standard winning virtual pull-tab tickets with a win value of $3.00, each having NO grid pattern.

In some embodiments, the paytable displays only the remaining prizes in a particular deck after one or more winning tickets have been distributed and played. This list of remaining winning prizes enables the player to assess whether the prize values are attractive enough to support continued game play.

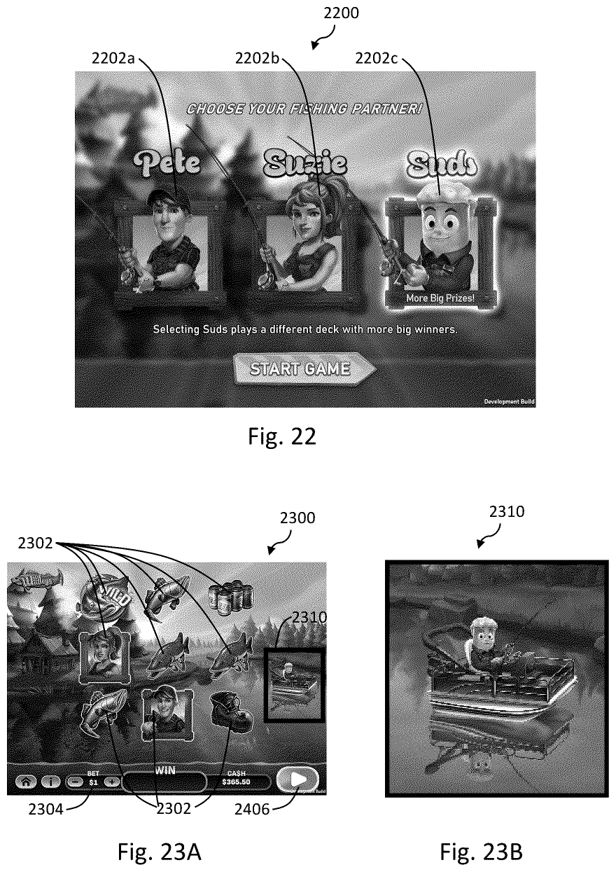

With reference now to FIGS. 22 through 28D there are shown illustrative game play screenshots of a watermarked virtual pull-tab game. In the illustrative embodiment, a pull-tab gaming system and method is described. In operation, a first electronic pull-tab deck is generated by wagering system 102. The first electronic pull-tab deck includes a first plurality of electronic pull-tab tickets. Additionally, a second electronic pull-tab deck is generated by wagering system 102, which includes a second plurality of electronic pull-tab tickets.

Further, the gaming devices 106 are communicatively coupled to the wagering system as described above. In the illustrative embodiment, the wagering system 102 provides two finite pool decks.

A first group of awarded prizes corresponding to a first deck includes a greater quantity of high value winning tickets than a second group of awarded prizes corresponding to a second deck. Also, the first group of awarded prizes corresponding to the first deck includes a lesser quantity of winning tickets than the second group of awarded prizes corresponding to the second deck.

An illustrative gaming client device 106 displays a selection instruction that receives a player selection input associated with selecting between the first deck and the second deck. The gaming client device then receives the selection game instruction before initiating game play. The selection game instruction is communicated from the gaming client to the wagering system, which controls access to a selected deck.

A predetermined electronic pull-tab ticket is transmitted from the selected deck to the gaming client device. The requesting gaming device displays an initial reveal animation corresponding to the electronic pull-tab ticket when the electronic pull-tab ticket is a watermarked winning electronic pull-tab ticket. In one embodiment, the initial reveal animation includes a game symbol sequence and an embedded watermark graphic enhancement. The requesting gaming device transforms the initial reveal animation to a final reveal animation corresponding to the electronic pull-tab ticket. The final reveal animation includes a particular non-zero win value corresponding to the electronic pull-tab ticket.

In the illustrative embodiment, each finite pool deck includes a plurality of predetermined electronic pull-tab results, in which each deck has an associated paytable that reflects a particular game volatility for each deck. Additionally, the selection instructions of the illustrative embodiment include selecting an avatar that is associated with a particular deck.

In FIG. 22 there is shown an illustrative selection that includes character selection start screen 2200 for a summer season version of the virtual pull-tab game displaying three avatar characters 2202a, 2202b, 2202c for selection. The character selection start screen 2200 is available to players whenever the game is idle, e.g., after completion of a game instance and before initiation of a game instance. In some embodiments, the character selection start screen 2200 enables players to select or change their previously selected avatar character 2202 only prior to requesting a ticket for play. In some embodiments, the character selection start screen 2200 enables players to select or change their previously selected avatar character 2202 after requesting a ticket for play, but prior to revealing the ticket value and/or result. In some embodiments, each avatar character 2202 is associated with unique game play graphic animations. In some embodiments, each avatar character 2202 is associated with its own unique paytable and/or volatility. In some embodiments, each avatar character is associated with a pull-tab game version that has a volatility and paytable unique to that avatar character.

When each avatar character is associated with unique game play graphic animations, a unique paytable, and/or volatility, players effectively lock-in their game play choice similar to bonus game play, but this selection is performed prior to initiation of a game instance instead of during a game instance.

The inventors theorize players may perceive a character as lucky or unlucky, prompting a desire to continue game play with a particular character 2202 or change their selected character between game instances. Inventors further theorize that player psychology may motivate continued game play in order to achieve a large win or roll-up graphic animation for each avatar character 2202 or an equal number of large wins for each avatar character 2202.

Two of the avatars in Wild Walleye, namely, Pete 2202a and Suzie 2202b share the same paytable. The other avatar, i.e., Suds 2202c, is associated with a big prize paytable with the offset being prizes are awarded less frequently. During game play, the selected avatar is featured in the extended prize rollup. For example, selecting Suds features Suds in the extended prize rollup and awards prizes according to Suds big prize paytable.

After selecting an avatar, the player places a wager and the gaming client initiates the request to receive an electronic pull tab ticket from a pull tab deck associated with the selected avatar. Winning prizes are awarded in the extended prize rollup by the selected avatar character. Note, the player's avatar selection may be switched to another avatar before placing a wager.

Referring now to FIG. 23A, there is shown there is shown an illustrative start screen 2300 displaying a losing grid of symbols 2302, the wager amount per ticket 2304, and the play button 2306 that causes the system driven Game Event reveal of the purchased ticket when a player input Game Action taps, selects, or otherwise interacts with the play button 2306. While the illustrative embodiment presents a 3×3 grid game display area, the term “grid” is interchangeable with similar terms, such as “row,” “column,” or “reel,” unless otherwise stated herein. Further, the grid may comprise a single row, a single column, multiple rows, and/or multiple columns, and is not limited to the illustrative 3×3 symbol grid depicted in FIG. 23A and other figures herein. Further still, each row or column of a grid is not limited to three (3) game symbol display positions and may include more of fewer game symbol display positions. The size and number of symbols may vary according to the gaming engineering constraints such as display size, game mechanics, game play and other such engineering constraints.

In some embodiments, the game prizes may be presented to players using a variety of visual constructs. For example, a wheel constructed of wedge slices may be used to display the game prizes, where each slice may represent one or more prizes or tickets. One of skill in the art would recognize from this description that the presentation of prizes need not be limited to symbol arrays, grids or wheels, and any construct may be used to display the game prizes.

In the illustrative embodiment, the player has selected avatar character 2202c Suds from the character selection start screen 2200. In response, to the selection made on the character selection start screen 2200, the start screen 2300 further displays an animation graphic of the selected avatar character 2310.

In the illustrative embodiment, the auto-close is “off.” The system driven auto-close Game Event may be selected by the operator. In some embodiments, the system driven auto-close Game Event automatically replaces a finite game pool with a new pool when all prizes exceeding a predetermined value for the deck have been exhausted and the game may no longer be desirable by players.

When the system driven auto-close Game Event is turned “ON,” a deck may automatically close and be replaced by a new deck when prizes over a game specific value set in the portal are gone. For example, a game may have 3 large value prizes and when the last prize is awarded, the deck may close, and a new deck may open. By way of example and not of limitation, the system driven auto-close Game Event is identified in the client game information when it is active, so players may know that it is active. A notification may also be given to all active clients when a new deck is open. This feature is attractive to players because they are always assured that there are always some valuable prizes remaining in a deck they may be playing.

When auto-close is enabled, the remaining prizes may be pooled into a progressive prize. Thus, in certain embodiments, proceeds from the auto-close may be applied to a progressive jackpot.

FIG. 23B shows an expanded inset view of the animation graphic of the selected avatar character 2310. In this expanded inset view, the animation graphic of the avatar character 2310 Suds is depicted fishing from a pontoon boat in the background of the start screen 2300.

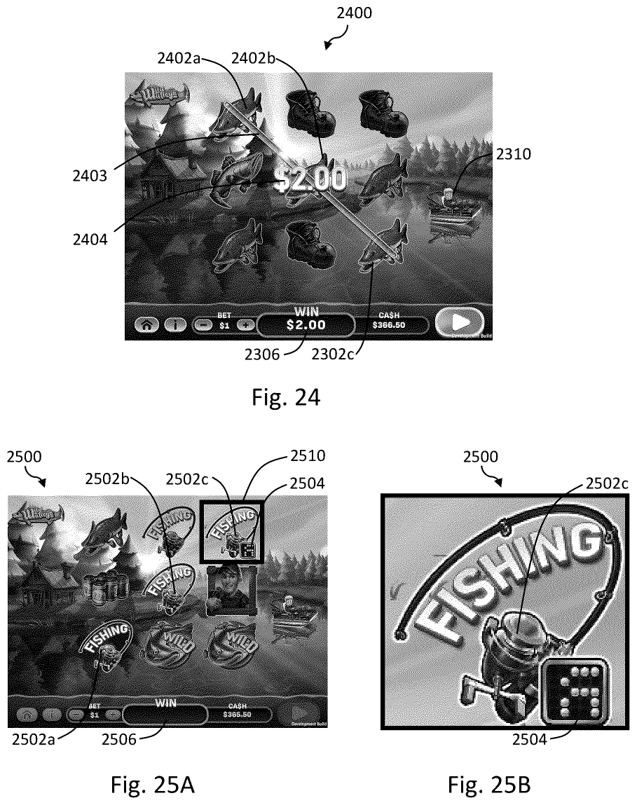

In FIG. 24 there is shown an illustrative final graphic 2400 for a standard winning virtual pull-tab ticket displaying a winning sequence of symbols 2402a, 2402b, 2402c along a descending diagonal of the 3×3 grid marked by a clear winning line 2403, a numerical winning value 2404, and an express full win value 2406 for the ticket. As discussed below, the paytable associated with this watermarked virtual pull-tab game includes only a single win value, $2.00, for the sequence of symbols 2402a, 2402b, 2402c.

FIGS. 25A through 27 show a sequence of graphic animations for game play of a watermarked virtual pull-tab ticket. In FIG. 25A there is shown the result of a winning system driven Game Event where a winning sequence of symbols 2502a, 2502b, 2502c that further include an embedded watermark graphic enhancement 2504 are displayed to the player. The prize resulting from this illustrative system driven Game Event is the result of a virtual pull-tab ticket request generated by a requesting gaming device and received by the wagering system. As previously described, the virtual pull-tab ticket is transmitted from the wagering system to the requesting gaming device and the requesting gaming device receiving the virtual pull-tab ticket eventually displays the resulting prize.

Although FIG. 25A shows the initial graphic animation 2500 for a winning watermarked virtual pull-tab ticket, there is a notable absence of a numerical win value in the ticket win value display box 2506. The player has been awarded a prize as represented by the three fishing symbols, in which one of the fishing symbols includes a watermark specific to an extended prize rollup corresponding to the prize. Recall, the paytable associates the watermark with a prize. Thus, the combination of three fishing symbols and the unique watermark can only be mapped to a single prize.

The winning sequence of symbols 2502a, 2502b, 2502c is associated with a range of win values, while the embedded watermark graphic enhancement 2504 is associated with a single win value. Thus, a player may realize from the initial graphic animation 2500 that the ticket is a winning ticket, but likely must view a detailed paytable to identify the precise value of the ticket from the grid pattern of the embedded watermark graphic enhancement 2504.

FIG. 25B shows an enlarged view 2510 of the game symbol 2502c and the embedded watermark graphic enhancement 2504. In this view 2510, the particular arrangement of highlighted tiles and empty tiles in the embedded watermark graphic enhancement 2504 grid are clearly visible. This arrangement of highlighted tiles and empty tiles is unique to the single winning value associated this ticket and this embedded watermark graphic enhancement 2504 grid, i.e. no other watermark grid arrangement is associated with the winning value of this ticket.

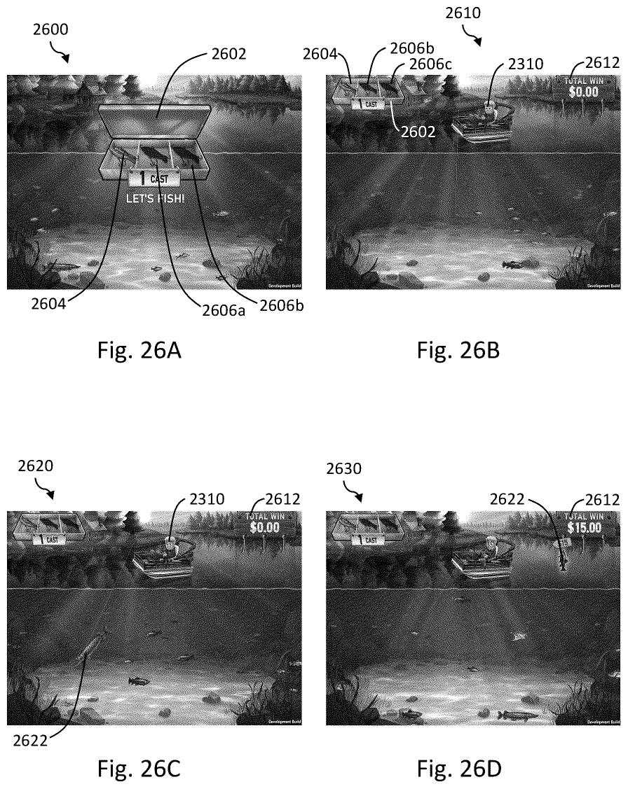

FIGS. 26A through 26D show a series of screenshots from an intermediate graphic animation, embodied as an extended roll-up animation, although, unlike a bonus roll-up the outcome of the ticket is pre-determined as indicated by the embedded watermark graphic enhancement. In FIG. 26A the screen view 2600 has shifted frame to display a split view of an underwater environment and an above water environment with a tackle box 2602 displaying a single lure 2604 and two empty slots 2606a and 2606b for additional lures. In another example, before purchasing an individual play, the player could have the option of selecting lures and this selection of lures is repeated should the resulting ticket have an embedded watermark with a fishing animated rollup. In the illustrative game only the single lure 2604 is presented, however in further embodiments the additional slots 2606a and 2606b hold additional lures. Each lure corresponds to a cast and catch animation that occur during the extended roll-up animation.

In FIG. 26B the screen view 2610 shows the next progression of the intermediate graphic animation where the tackle box 2602 has shifted out of the center of the screen view 2610, the character avatar 2310 is visible fishing from a pontoon boat, and a total win counter 2612 is now displayed. In screen view 2610 the character avatar 2310 Suds has cast the first and only lure 2604, but not yet caught anything to register a win value on the total win counter 2612, which reads $0.00 currently.

In FIG. 26C the screen view 2620 shows the next progression of the intermediate graphic animation where the character avatar 2310 cast of the first and only lure 2604 has caught a fish 2622. The fish 2622 represents an unknown win value. In the illustrative embodiment, only a single lure 2604 is available for casting and only a single fish 2622 can be caught, as such, the caught fish 2622 represents not just a partial win value but a total win value for the ticket.

In FIG. 26D the intermediate graphic animation finishes with a tally animation shown in screen view 2630, which shows the fish 2622 caught and hung for display. The caught fish 2622 includes a value tag showing a $15.00 value and the total win counter 2612 has recorded the $15.00 win value of the caught fish 2622. In this illustrative example, only a single lure 2604 is associated with the ticket and the $15.00 win value of the caught fish 2622 is the only value of the ticket. At the conclusion of the intermediate graphic animation shown in screen view 2630 the total win counter 2612 displays the full win value of the ticket, which is equal to the accumulated value of all caught fish.

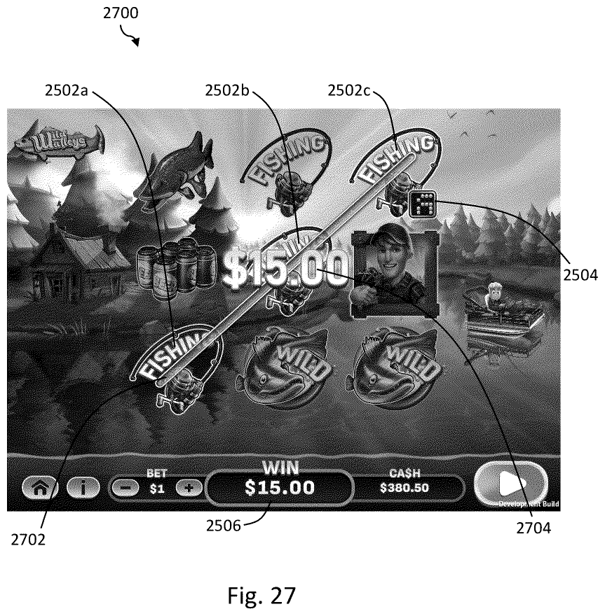

FIG. 27 shows a screen shot view 2700 of the final graphic animation for the illustrative watermarked virtual pull-tab ticket. In the illustrative final graphic animation, the grid with the winning symbol sequence 2502a, 2502b, 2502c with the embedded watermark graphic enhancement 2504 is shown again. However, the final graphic animation further includes a clear winning line 2702, a numerical full winning value 2704 for the ticket overlaid on the symbol sequence so that the player does not have to refer to the paytable to determine the full win value associated with the embedded watermark graphic enhancement 2504. Additionally, the full win value is presented in the ticket win value display box 2506.

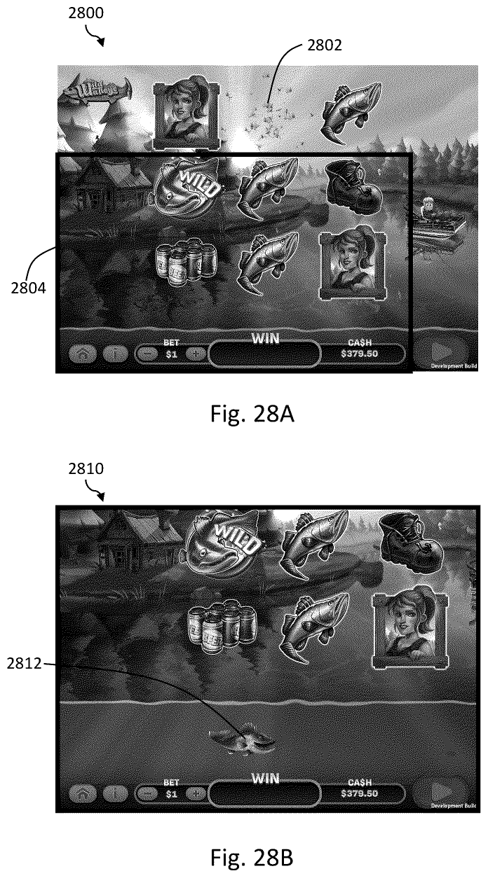

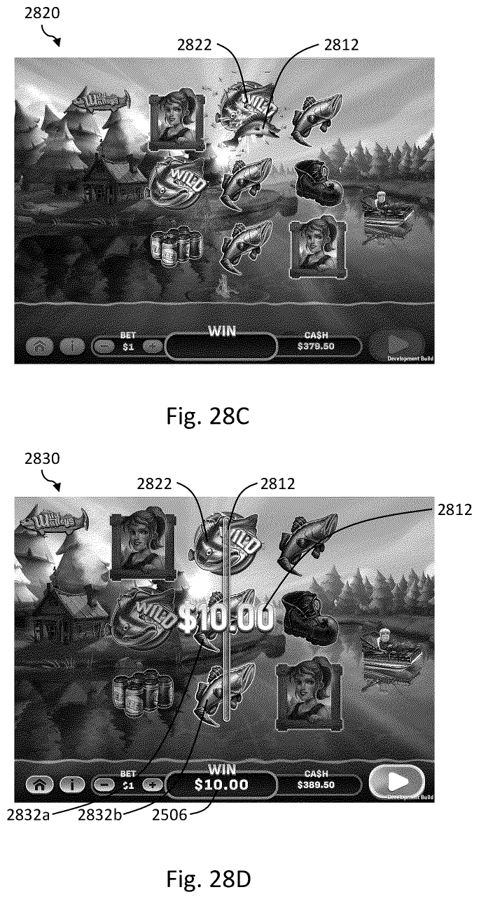

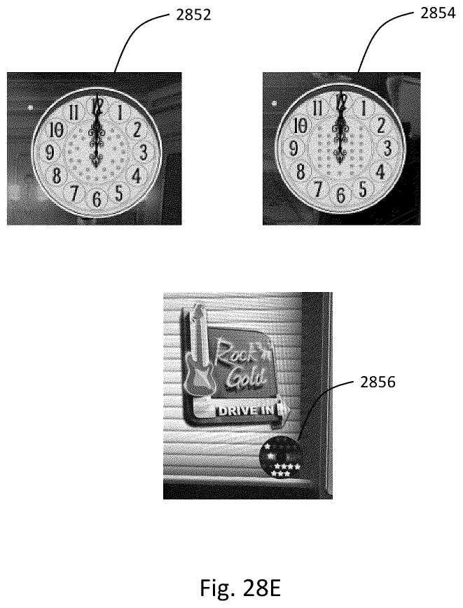

With reference now to FIGS. 28A through 28D there is shown illustrative game play screenshots of a standard winning ticket from a watermarked virtual pull-tab deck. In FIG. 28A an initial wild symbol graphic animation of a grid of game symbols is displayed with an empty symbol position 2802. In the illustrative embodiment, the empty symbol position 2802 is occupied by a mass of flies. A box 2804 identifies an inset frame of the screen view 2800, which becomes the focal frame for the intermediate graphic animation.

In FIG. 28B the screen view 2810 shows a first portion of an intermediate graphic animation that has shifted to the inset frame 2804 of the screen view 2800 and now displays a fish animation 2812 below water.

In FIG. 28C the intermediate graphic animation continues with screen view 2820 that has returned its focal frame to that of screen view 2800, showing the full game grid of symbols. In this portion of the intermediate graphic animation the fish animation 2812 has jumped out of the water to eat the mass of flies occupying the empty symbol position and transformed the mass of flies into a wild symbol 2822.

In FIG. 28D the screen view 2830 shows a final graphic animation for the illustrative virtual pull-tab ticket. In the illustrative final graphic animation, the wild symbol 2822 is an element of a winning symbol sequence that includes the initially revealed symbols 2832a and 2832b. The screen view 2830 of the final graphic animation further includes a clear winning line 2834, a numerical full winning value 2836 for the ticket overlaid on the winning sequence of symbols 2822, 2832a, 2832b so that the player does not have to refer to the paytable to determine the full win value associated with the symbol sequence. Additionally, the full win value is presented in the ticket win value display box 2506.

A first illustrative electronic pull-tab ticket that includes watermark data is provided. This first illustrative electronic pull-tab ticket may also be referred to as a “big” ticket because it includes all the information needed to present the game on the gaming client. More specifically, the illustrative electronic pull-tab ticket includes a plurality of watermark objects capable of presenting watermark data on a client device. Additionally, once the big ticket is received, the gaming client proceeds to decode and process the “big” electronic pull-tab ticket structure is described. Further, the presentation of the watermark is also described.

An illustrative big electronic pull-tab ticket having watermark data is presented below as nested JSON code. Note, the illustrative big ticket includes all the information that is needed for the gaming client to display the various animations, watermarks, and other game elements needed to the present the game on the gaming client. In this illustrative big ticket embodiment, the ticket data objects have been previously shuffled by the deck generator described above.

```
  {“prize_index”:0,
  “ticket”:{“id”:0,“sample_id”:0,“total_prize”:49800},
  “play”:{“prizes”:[{“kind”:“left”,“line”:1,“paytable”:0,“prize”:49800,“symbols”:[false,tr
ue,false],[false,true,false],[false,true,false]]}],
    “symbols”:[“f1”,“f1”,“p3”],[“p3”,“f1”,“p2”],[“p1”,“f1_2”,“p6”]]}}
```

The illustrative big electronic pull-tab ticket includes a plurality of objects, which are defined more clearly in the Table below. For simplicity, the nested JSON code is presented below in a tabular convention.

Inventor(s): Weaver, Jon

| prize | index of the prize prior to deck shuffling | |
|---|---|---|
| index | | |
| ticket | information of the particular ticket | |
| | id | unique identifier for this ticket |
| | sample_id | unique identifier for this sample |
| | total prize | total prize in pennies |
| play | information about how to display a result | |
| | prizes | information about each prize in this ticket (in this |
| | | case just 1) |

| | |
|---|---|
| kind | could be line, scatter, left to right, right |
| | to left, top to bottom, etc. |
| line | which pay line is responsible for this win |
| paytable | indicator of which paytable this win came |
| | from |
| prize | prize in pennies for this win |
| symbols | list of which symbols contributed to this |
| | win. True indicating a paying symbol and |
| | false indicating a non-paying symbol |

| | |
|---|---|
| symbols | list of symbols to show to the player. The |
| | watermarking may be encoded in this list. As an |
| | example, in the JSON above, a watermarked symbol is |
| | identified by the symbol reference followed by an ‘_’, |
| | followed by a watermark ID. In this case, the third |
| | occurrence of the ‘f’ symbol is marked with a |
| | watermark with watermark ID of 2. |

In the illustrative “big” ticket example provided above, a watermark ID of ‘2’ was presented. This illustrative watermark ID of ‘2’ refers to an index associated with a watermark table stored on the gaming client device. The watermark table may be embodied as a look up table that indicates the type of watermark and placement of the watermark for a total prize awarded. By way of example and not of limitation, the ID number 2 may be associated with an index associated with an array of fruit watermarks with each fruit having a different unique identifier.

In another embodiment, the ID number 2 may be an index into a set of known grid watermarks, in which there may be a finite number of predetermined 5×5 grid patterns of watermarks and this index represents a reference to one of the watermarks.

In yet another embodiment, the ID number 2 may be an encoded number referring to which spots on the watermark grid are highlighted. For example, the number after the underscore may be an unsigned integer where each bit of the unsigned integer represents the status of one of the spaces on the grid. In an illustrative 5×5 card, this can be represented by 25 bits of 0's and 1's and if a spot on the grid is a 1, that spot is highlighted in the water mark. In this example of the ‘f’ symbol followed by a ‘2’, the bit representation of the number 2 may indicate that this watermark is a 5×5 grid with the second spot highlighted as on and the rest are off.

In a still further embodiment, additional fields may be present in the electronic pull-tab ticket that provide further instructions about how to display the watermark and reveal the game outcome such as associating the watermark with a game symbol, instead of a game prize. For example, the watermark may be associated with a game title so that a different watermark is presented for each different prize, and the watermark is presented at the end of the title of game being played.

After decoding and processing the watermark associated with the electronic pull-tab ticket structure, the associated entertaining prize roll-up is initiated. More specifically, the decoding of the watermark to a win amount occurs before the entertaining win presentation via the animated prize rollup is described.

By way of example and not of limitation, the ID number 2 operates as an identifier of the watermark, which may then index to a lookup table on that game client device that has different ways of displaying the outcome. For example, in Cash Mountain, the ID number 2 may indicate a prize of 49800, which presents the yeti choosing the tent to reveal a prize of 29800 and then choosing the axe to reveal a prize of 20000 for a total prize 49800. Additionally, if the ID number is ‘3’, this may also indicate a prize of 49800, however, the prizes are reversed so that the yeti choosing the tent reveals a prize of 20000 and then choosing the axe reveals a prize 29800 for a total prize of 49800.

In a still further example, the ID number 2 may be used to determine how to show the watermark and may not be used in determining the entertaining rollup process. The game client may use the win amount to determine how to show the entertaining rollup, which may include randomly choosing through a list of pre-determined paths for the entertaining rollup or by generating a random path for the entertaining rollup after receiving the ticket and win amount from the system.

The big pull-tab ticket embodiment may also include information about progressives associated with a progressive game server (not shown). Further the big pull-tab ticket embodiment can support tournament play and communicate tournament information to the gaming client.

The systems and methods described herein also support a “small” ticket embodiment. Generally, the small ticket embodiment transactions a small amount of ticket data (e.g. total win amount) to the gaming client, and the gaming client then proceeds to request supplemental ticket information from one or more of the server-side components described above.

In a “small” ticket embodiment, the deck generator server 305 may shuffle data objects as described above, however, the data objects may only contain a small amount of ticket data, e.g., such as the total win amount. In this small ticket embodiment, the system receives a request from the gaming client for an electronic pull-tab ticket and the system returns the shuffled ticket and win amount. Additionally, upon request by the gaming client, the system may generate additional data objects to populate the selected electronic pull-tab ticket with more information relating to the display of that prize.

In the small ticket embodiment, the small pull-tab ticket includes the value of the prizes and the total win amounts associated with the small pull-tab ticket. In some examples, the win amount may represent only 1 payline of the ticket, or may represent a progressive win, or it may represent a multiple chance win, or it may represent some other indicator of how the game should behave when a ticket is either shuffled, generated or received by the game. As an example, two different versions of prize lists are shown and described below for the small pull-tab ticket embodiment.

In the illustrative prize list, the win values represent the total win amounts for each ticket. Based on the small pull-tab ticket data (described elsewhere in this watermarking example), the game will award the prize according to the additional information included in the ticket data. This small pull-tab ticket data may include the symbols that show animated features to display, progressive wins, bonus rounds, multiple chance tickets or awards of some other value depending on regulations and game features. This small pull-tab ticket data may be shuffled with the deck when the deck is generated, it may be available on a lookup table that resides on the game client, it may be available in the cloud for the game to request upon receiving a ticket, it may be embedded in the ticket and received by the game, and it may be generated by the system in real time after the deck is shuffled when the client requests a ticket.

For example, the prize list shown below indicates that a generated deck of 7500 tickets should include 4717 tickets that pay $0, two (2) tickets that pay $300.00, etc. The samples field indicates the number of ways the deck generator can choose to display the final result. In this small pull-tab ticket example, the ticket data set includes 1500 prize samples that $0.

```
{
  “manufacturer”: “Pilot Games”
  “title”: “Cash Mountain”,
  “wager”: 50,
  “form”: “AB7655”,
  “version”: “1”,
  “payout”: 85.0,
  “ticketcount”:7500,
  “prizelist”:[
    {“value”:0, “qt”:4717, “samples”:1500},
    {“value”:3000, “qt”:2, “samples”:20},
    {“value”:2000, “qt”:2, “samples”:20},
    {“value”:1500, “qt”:2, “samples”:20},
    {“value”:1000, “qt”:2, “samples”:20},
    {“value”:750, “qt”:6, “samples”:60},
    {“value”:600, “qt”:8, “samples”:80},
    {“value”:500, “qt”:12, “samples”:60},
    {“value”:400, “qt”:12, “samples”:60},
    {“value”:300, “qt”:25, “samples”:63},
    {“value”:250, “qt”:30, “samples”:75},
    {“value”:200, “qt”:30, “samples”:75},
    {“value”:150, “qt”:31, “samples”:78},
    {“value”:100, “qt”:180, “samples”:270},
    {“value”:75, “qt”:150, “samples”:225},
    {“value”:50, “qt”:250, “samples”:300},
    {“value”:25, “qt”:250, “samples”:300},
      ]
```

In the above small pull-tab ticket example, the deck generator generates a new deck of 7500 total tickets, which must include 4717 tickets that pay $0 selected randomly from the 1500 $0 paying tickets. In the case of the $300.00 ticket, the deck generator must randomly select two (2) $300.00 tickets to include in the shuffled deck of 7500 from the twenty (20) $300.00 paying tickets. This selection can be performed with or without replacement and duplicate selections may or may not be allowed depending on jurisdiction rules or game design choices.

In another small pull-tab ticket example, the deck generator may use this table to create a weighted random draw of the total win amounts and sequence 7500 win amounts for the shuffled deck. In this example, the total win amount would be sent to the gaming client as the result of the ticket without any additional ticket data. The gaming client may either use that win amount combined with local data and tables to create the display of that winning ticket, or the gaming client may make a request to a ticket generator cloud service to create the display of the winning ticket. In this example, the display of the result may also be performed on the gaming client without requesting any additional ticket data. For example, the gaming client device may receive a ticket prize of $0, award a ticket of $0, randomly select symbols to fill the grid positions, and the gaming client may evaluate the random selection until a random selection matches the ticket pay amount, which is $0. Alternatively, the gaming client may have a table of predefined $0 tickets and will select one at random.

In another small pull-tab ticket example, the deck may only be shuffled with win values and real time when the game client requests a ticket, the ticket may be paired up and/or embedded with a predefined ticket sample and transmitted back to the game client for display.

```
“ticketcount”:7500,
“prizelist”:[
  {“value”:0, “qt”:4717, “samples”:1500},
  {“value”:0, “qt”: 1285, “samples”:200, “almost_win”:”feature12”,
“gameplay”:{“almost_win”:”feature12”}},
  {“value”:0, “qt”: 127, “samples”: 127, “almost_win”:”feature1”,
“gameplay”:{“almost_win”:”feature1”}},
  {“value”:0, “qt”: 126, “samples”: 126, “almost_win”:”feature2”,
“gameplay”:{“almost_win”:”feature2”}},
  {“value”:3000, “qt”:2, “samples”:20, “gameplay”:{“feature”:”feature1”}},
  {“value”:2000, “qt”:2, “samples”:20, “gameplay”:{“feature”:”feature1”}},
  {“value”:1500, “qt”:2, “samples”:20, “gameplay”:{“feature”:”feature1”}},
  {“value”:1000, “qt”:2, “samples”:20, “gameplay”:{“feature”:”feature1”}},
  {“value”:750, “qt”:6, “samples”:60, “gameplay”:{“feature”:”feature2”}},
  {“value”:600, “qt”:8, “samples”:80, “gameplay”:{“feature”:”feature2”}},
  {“value”:500, “qt”:12, “samples”:60},
  {“value”:400, “qt”:12, “samples”:60},
  {“value”:300, “qt”:25, “samples”:63},
  {“value”:250, “qt”:30, “samples”:75},
  {“value”:200, “qt”:30, “samples”:75},
  {“value”:150, “qt”:31, “samples”:78},
  {“value”:100, “qt”:180, “samples”:270},
  {“value”:75, “qt”:150, “samples”:225},
  {“value”:50, “qt”:250, “samples”:300},
  {“value”:25, “qt”:250, “samples”:300},
    ]
```

In the above prize list, additional information may be included with different win levels. For example, the win amounts that produce a $0 paying prize may be grouped together such that there is more control over how these $0 paying prizes are displayed. As an example, there are four (4) different levels of $0 paying prizes, in which each level has their own weights for representation in the final shuffled deck of 7500 tickets. Also, the illustrative shuffled deck has 1285 tickets that produce a set of symbols that pay $0, yet the 1285 reflect an “almost win” that is one (1) symbol away from both a feature1 and a feature2. The shuffled deck also has 127 almost win tickets that paid $0 and were only one (1) symbol away from feature1, and the shuffled deck has 126 almost win tickets that paid $0 and were only one (1) symbol away from feature2. Also indicated in the small pull-tab ticket prize list are example counts and win amounts for each of the extended features for this game title, and this assists the deck generator in ensuring every deck has a consistent feel to the game.

As previously stated, the samples field indicates the number of ways the deck generator can choose to display the final result. Thus, non-zero pay amounts may also be listed multiple times because the samples for each of those wins may display the final non-zero pay amounts differently. For example, a game may have two (2) $5.00 entries in the prize list, one of the $5.00 may have two hundred (200) required tickets, and the other $5.00 may have twenty (20) required tickets. The samples associated with the $5.00 win with two hundred (200) required tickets may be three (3) cherries, the samples associated with the $5.00 win with twenty (20) samples may be associated with three (30 bars. In this illustrative paytable, three (3) cherries and three (3) bars both pay $5.00. With these two different sample sets broken out as different entries in the prize list, each shuffled deck may have a similar feel in that the $5.00 result of three (3) cherries will be ten (10) times more common than the $5.00 result with three (3) bars in every deck shuffle. Alternatively, and possibly less effective method, may have one (1) entry for $5.00 with a total of two hundred twenty (220) tickets. The deck generator shuffles a deck with two hundred twenty (220) tickets with a non-constant ratio of three (3) cherry wins to three (3) bars.

With respect to the presentation of the watermark for the small pull-tab ticket embodiment, the illustrative look and design of the watermark may vary. The watermark includes an enhancement to a standard symbol such that at a quick glance by a player there is no perceivable difference, however, under closer inspection the differences between symbols without watermarks and symbols with watermarks and the difference between individual watermarks are observable.

By way of example and not of limitation, the shuffled small pull-tab ticket may include a win amount and a plurality of ticket symbols. However, information related to watermarking or animated prize display may not be present in the shuffled small pull-tab ticket. A system component may created additional data fields after deck shuffling at the time of the electronic pull-tab ticket request. The additional data fields for the small ticket embodiment may include the following watermark data:
play: information about how to display this result
   prizes: information about each prize in this ticket (in this case just 1)
      kind: could be line, scatter, left to right, right to left, top to bottom, etc. . . .
      line: which pay line is responsible for this win
      paytable: indicator of which paytable this win came from
      prize: prize in pennies for this win
      symbols: list of which symbols contributed to this win. True indicating a paying symbol and false indicating a non-paying symbol
symbols: list of symbols to show to the player. The watermarking may be encoded in this list.

In the small pull-tab ticket embodiment, the deck generator server 305 utilizes a set of data files that describe the contents of a shuffled electronic pull-tab ticket deck. In operation, information such as the amount of tickets, win amounts, number of winners for each win amount, and number of tickets that match the criteria for each pay level described. The following data objects can be used to describe to the deck generator how to create the decks.

One type of data object may be a description of how individual symbols pay. The system may use this as a mapping of how to generate decks. Some or all of the information may be used when the decks are generated, and others may be used to populate the ticket upon request from the gaming client.

Symbols: The list of symbols for a particular title that may be used for this game

Scatters: any symbols in the list of symbols that may be used as scatters

Paytable: describes the sequence of symbols and their pay amount

Illustrative JSON code may appear as follows:

```
  “symbols”: [“p1”,”p2”,”p3”,”p4”,”p5”,”p6”,”p7”,”p8”,”feature1”,”feature2”],
  “scatters”: [“feature1”,”feature2”],
  “paytable”: {
    “prizes”: [
    {“sequence”: [“p1”, “p1”, “p1”, “p1”, “p1”], “pays”: 6000, “mode”:”left”},
    {“sequence”: [“p1”, “p1”, “p1”, “p1”], “pays”: 3000, “mode”:”left”},
    {“sequence”: [“p1”, “p1”, “p1”], “pays”: 1500, “mode”:”left”},
    {“sequence”: [“p2”, “p2”, “p2”, “p2”, “p2”], “pays”: 4000, “mode”:”left”},
    {“sequence”: [“p2”, “p2”, “p2”, “p2”], “pays”: 2000, “mode”:”left”},
    {“sequence”: [“p2”, “p2”, “p2”], “pays”: 1200, “mode”:”left”},
    {“sequence”: [“p3”, “p3”, “p3”, “p3”, “p3”], “pays”: 1500, “mode”:”left”},
    {“sequence”: [“p3”, “p3”, “p3”, “p3”], “pays”: 1000, “mode”: “left”},
    {“sequence”: [“p3”, “p3”, “p3”], “pays”: 600, “mode”:”left”},
    {“sequence”: [“p4”, “p4”, “p4”, “p4”, “p4”], “pays”: 1200, “mode”:”left”},
    {“sequence”: [“p4”, “p4”, “p4”, “p4”], “pays”: 800, “mode”:”left”},
    {“sequence”: [“p4”, “p4”, “p4”], “pays”: 500, “mode”:”left”},
    {“sequence”: [“p5”, “p5”, “p5”, “p5”, “p5”], “pays”: 600, “mode”:”left”},
    {“sequence”: [“p5”, “p5”, “p5”, “p5”], “pays”: 400, “mode”:”left”},
    {“sequence”: [“p5”, “p5”, “p5”], “pays”: 200, “mode”:”left”},
    {“sequence”: [“p6”, “p6”, “p6”, “p6”, “p6”], “pays”: 500, “mode”:”left”},
    {“sequence”: [“p6”, “p6”, “p6”, “p6”], “pays”: 300, “mode”:”left”},
    {“sequence”: [“p6”, “p6”, “p6”], “pays”: 150, “mode”:”left”},
    {“sequence”: [“p7”, “p7”, “p7”, “p7”, “p7”], “pays”: 400, “mode”:”left”},
    {“sequence”: [“p7”, “p7”, “p7”, “p7”], “pays”: 200, “mode”:”left”},
    {“sequence”: [“p7”, “p7”, “p7”], “pays”: 100, “mode”:”left”},
    {“sequence”: [“p8”, “p8”, “p8”, “p8”, “p8”], “pays”: 300, “mode”:”left”},
    {“sequence”: [“p8”, “p8”, “p8”, “p8”], “pays”: 150, “mode”:”left”},
    {“sequence”: [“p8”, “p8”, “p8”], “pays”: 50, “mode”:”left”},
    {“sequence”: [“feature2”,”feature2”,”feature2”,”feature2”,”feature2”], ”pays”:
0, “mode”:”line”, “feature”: [“feature2”]},
    {“sequence”: [“feature1”,”feature1”,”feature1”,”feature1”,”feature1”], ”pays”:
0, “mode”:”line”, “feature”: [“feature1”]},
```

In an illustrative example of data objects related to the distribution of prizes, the distribution of prizes data objects can be described as follows:
“manufacturer”: the Manufacturer of this game
“title”: Game Title
“wager”: Wager (in this example it is shown in pennies, but it could be dollars, credits, or some other form of currency)
“form”: Unique identifier for this data set
“version”: Version of this data set
“payout”: Payback Percentage
“ticketcount”: Number of tickets in the shuffled deck
“prizelist”: list of prizes
   Additionally, the distribution of prizes data objects may also include simulated reel strips, or random prizes could also be utilized.

Some examples of watermarks having a grid formation as shown in FIG. 25B and FIG. 27. In other examples, the watermark may be embedded into the symbol as shown in the clock symbols of FIG. 28E. More specifically, clock 2852 is distinct from clock 2854. However, the clock symbol does not share a grid formation, instead, the watermark has a circular form. Another illustrative symbol is presented in watermark 2856 in FIG. 28E, which includes a watermark 2856 feature that is separate and distinct from the Rock ‘n Roll Drive In game symbol.

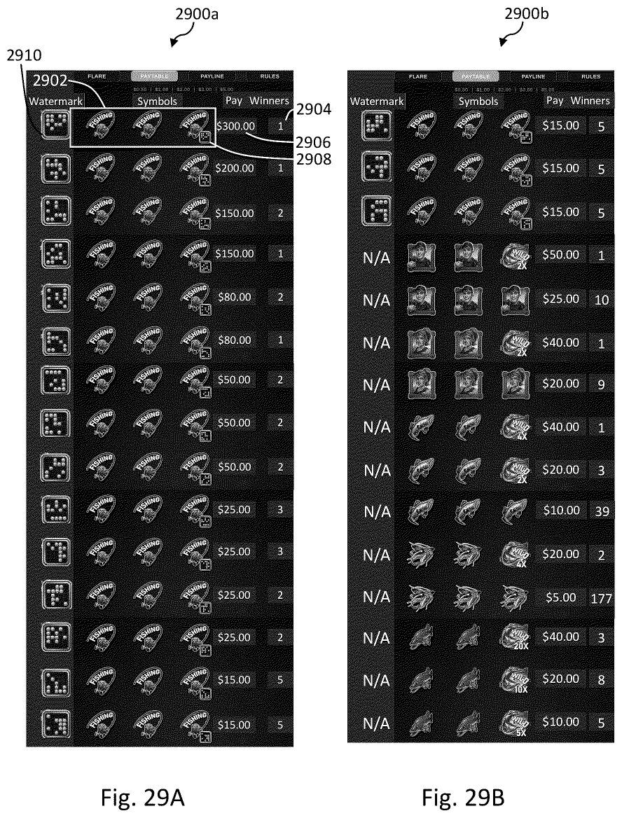

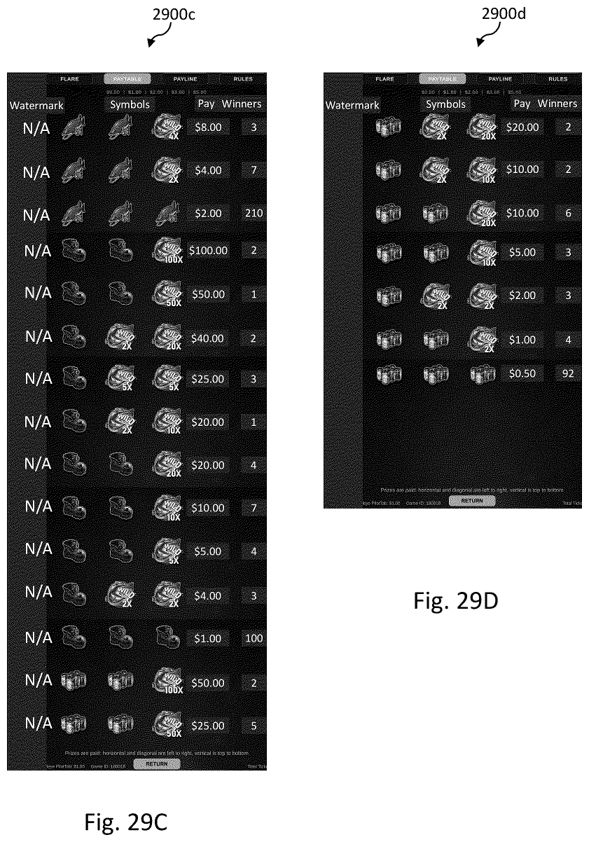

With reference now to FIGS. 29A through 29D show illustrative screenshots 2900a through 2900d of a composite single watermarked virtual pull-tab ticket paytable are shown. The watermarked and standard prizes are listed in a “paytable” menu view in the illustrative watermarked virtual pull-tab game display. The illustrative screen shots 2900a through 2900d include depictions of symbol sequences 2902, the number of tickets 2904 having the symbol sequence 2902 in the illustrative virtual pull-tab deck, and the full win value 2906 of the prize associated with each of the pull-tab tickets. The available prizes awarded for each ticket are associated with a wager of $1.00, which is indicated in each of FIGS. 29A through 29D. Each watermarked symbol sequence 2902 further includes the watermark graphic enhancement 2908 embedded in certain symbol(s) that uniquely identifies the win value of the symbol sequence. For the purpose of clarity, the embedded watermark graphic enhancement 2908 for each watermarked symbol sequence is reproduced in an enlarged format 2910. This enlarged format 2910 clearly shows that each grid pattern is unique, although some grid patterns are associated with the same win value as one or more other grid patterns. In these examples, while multiple grid patterns may indicate the same win value, each grid pattern may be associated with a particular character avatar and associated unique intermediate graphic animation.

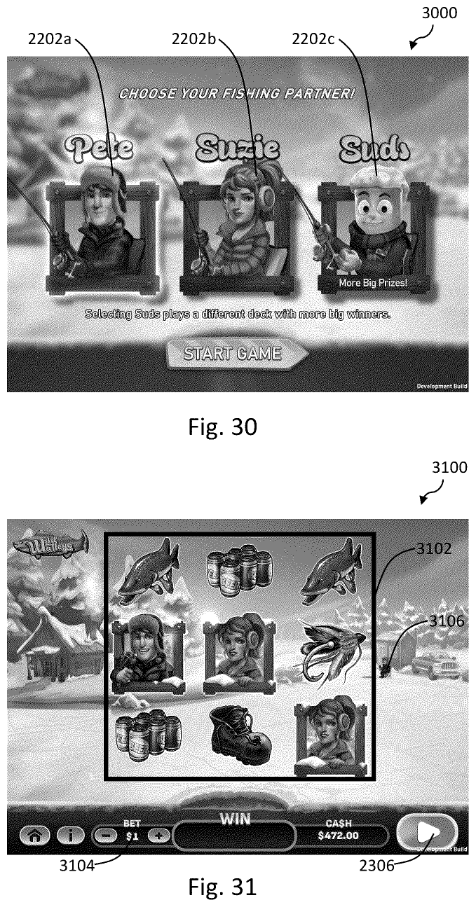

Referring now to FIG. 30 there is shown a view 3000 of an illustrative character selection start screen for a winter season version of the watermarked virtual pull-tab game. In some embodiments, players may select between the summer season game version and the winter season game version using player input prior to purchasing a game ticket. In some embodiments, players may select between the summer season game version and the winter season game version using player input prior to initiating a game instance. In some embodiments, players may select between the summer season game version and the winter season game version using player input during an initiated game instance. This view 3000 again displays the three avatar characters 2202a, 2202b, 2202c, with avatar character 2202a Pete selected by a player prior to initiation of a game instance to play a virtual pull-tab ticket.

In some embodiments, the winter season pull-tab game version has the same volatility and paytable as the summer season pull-tab game version. In some embodiments, the winter season pull-tab game version has a different volatility and paytable than the summer season pull-tab game version.

With reference to FIG. 31 there is shown an illustrative start screen 3100 displaying a losing grid of symbols 3102, the wager amount per ticket 3104, and the play button 2306. In response, to the selection made on the character selection start screen 3000, the start screen 3100 further displays an animation graphic of the selected avatar character 3106 Pete.

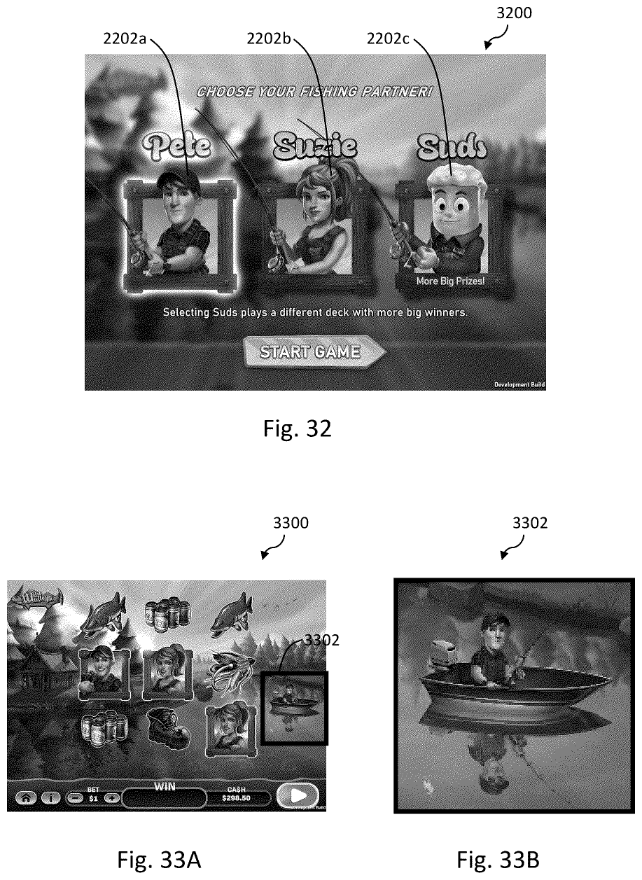

Referring now to FIG. 32 there is shown a view 3200 of the character selection start screen for the summer season game version. This view 3200 again displays the three avatar characters 2202a, 2202b, 2202c, with avatar character 2202a Pete selected by a player prior to initiation of a game instance to play a virtual pull-tab ticket.

With reference to FIG. 33A there is shown an illustrative start screen 3300 for a summer season game version. In response, to the selection made on the character selection start screen 3200, the start screen 3300 further displays an animation graphic of the selected avatar character 3106 Pete fishing in a pontoon boat in the background.

FIG. 33B shows an expanded view of the background animation graphic of the selected avatar character 3302 Pete in his pontoon boat.

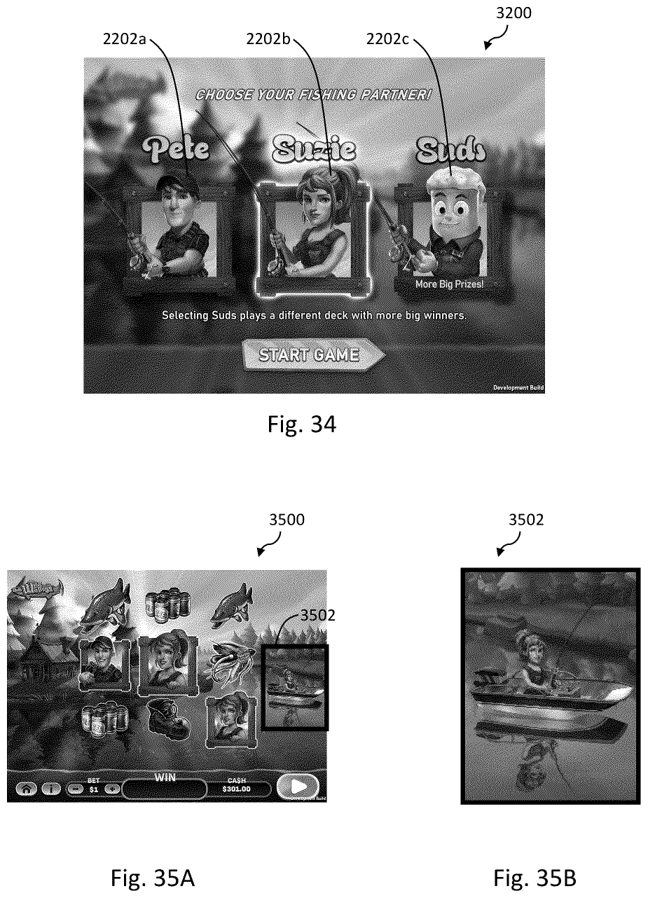

Referring now to FIG. 34 there is shown a further view 3400 of the character selection start screen for the summer season game version. This view 3400 again displays the three avatar characters 2202a, 2202b, 2202c, with avatar character 2202b Suzie selected by a player prior to initiation of a game instance to play a virtual pull-tab ticket.

In FIG. 35A there is shown an illustrative start screen 3500 for the summer season game version. In response, to the selection made on the character selection start screen 3400, the start screen 3500 further displays an animation graphic of the selected avatar character 3502 Suzie fishing in a pontoon boat in the background.

FIG. 35B shows an expanded view of the background animation graphic of the selected avatar character 3502 Suzie in her pontoon boat.

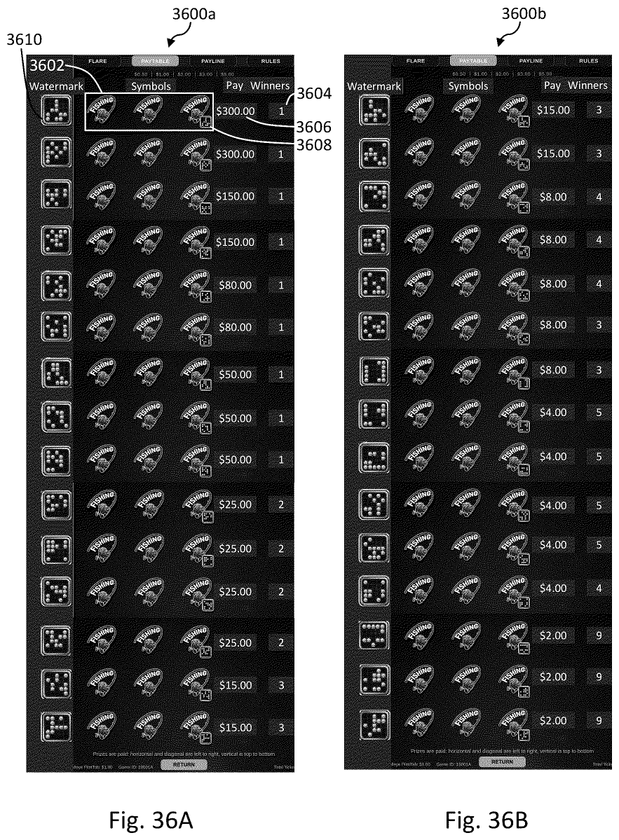

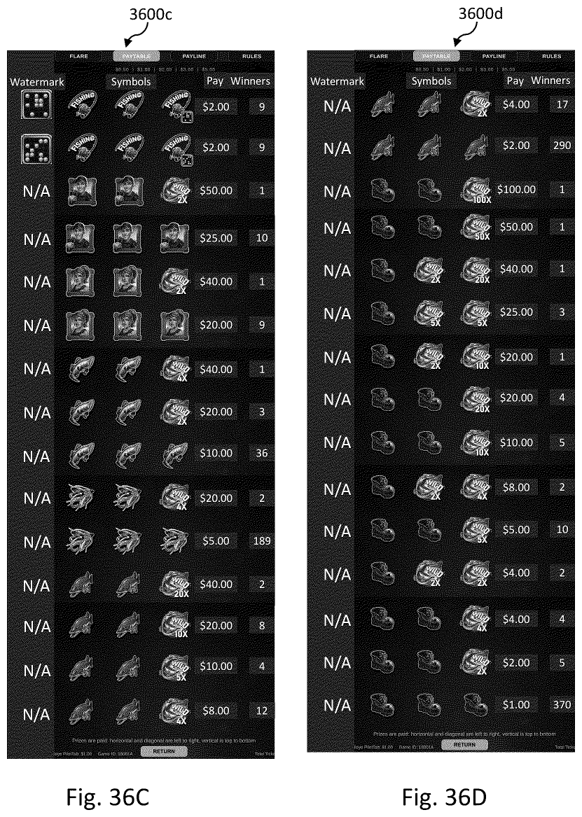

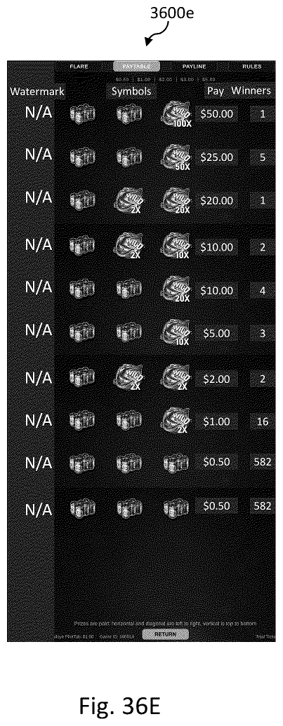

With reference now to FIGS. 36A through 36D there are shown illustrative screenshots 3600a through 3600d of a composite single watermarked virtual pull-tab ticket paytable are shown. The watermarked and standard prizes are listed in a “paytable” menu view in the illustrative watermarked virtual pull-tab game display. The illustrative screen shots 3600a through 3600d include depictions of symbol sequences 3602, the number of tickets 3604 having the symbol sequence 3602 in the illustrative virtual pull-tab deck, and the full win value 3606 of the prize associated with each of the pull-tab tickets. The available prizes awarded for each ticket are associated with a wager of $1.00, which is indicated in each of FIGS. 36A through 36D. Each watermarked symbol sequence 3602 further includes the watermark graphic enhancement 3608 embedded in certain symbol(s) that uniquely identifies the win value of the symbol sequence. For the purpose of clarity, the embedded watermark graphic enhancement 3608 for each watermarked symbol sequence is reproduced in an enlarged format 3610. This enlarged format 3610 clearly shows that each grid pattern is unique, although some grid patterns are associated with the same win value as one or more other grid patterns. In these examples, while multiple grid patterns may indicate the same win value, each grid pattern may be associated with a particular character avatar and associated unique intermediate graphic animation.

The illustrative gaming systems and methods presented above may include a plurality of server applications that configured to provide high-availability and redundancy, processes all inputs, generates outputs, and maintains a central database for accounting, game play, system configuration data, and other such data types. By way of example and not of limitation, critical system data regarding clients may be maintained in a repository associated with the illustrative gaming system. Historical games results and leader board information may be maintained. Printable versions of this information may be available on the portal.

The illustrative client devices described in the illustrative embodiments are communicatively coupled to a gaming system database, which stores client device data. Additionally, the illustrative gaming system database is configured to be secure. Furthermore, the illustrative gaming system database manages the data that is received from client devices in geographically dispersed gaming venues.

The illustrative centralized gaming system may be disposed in a central site as described. The illustrative centralized gaming system may process information received over the internet backbone from client devices such as mobile devices, management terminals and other such client devices.

The illustrative wagering system manages the funding of game play and operation of wagering games and overall system management. All gaming messaging between servers and client devices is sent and received over a secure internet network that directs network traffic to the appropriate server elements. A portal service receives messages from management terminals and provides functionality to authorized users to control the system and access real-time and historical data. All server applications are structured to be deployable in a virtual server environment, configured for high availability with fail-over capabilities on hardware components and database structures that keep a multiplicity of all data records.

By way of example and not of limitation, the games supported by the

wagering system include electronic pull-tabs, electronic pull-tab tournaments, multiple chance pull-tabs, linked bingo, high-speed linked bingo with entertainment, bingo tournaments, slot games, video poker, multi-player poker, blackjack, roulette, and other casino or entertainment games.

Many game types, including electronic pull-tabs and the entertainment aspect of linked bingo may have bonus modes that award prizes based on a theme-specific animation. Often these features take more play time than a conventional game. While these features are entertaining, many players who have played the games for some period of time find the time spent in animation wasteful. Therefore, this system features a unique system driven Game Event at the beginning of any potentially long animation, bonus or otherwise. The player is presented with a screen announcing the animation and then is presented with opportunity to input a Game Action to proceed with the animation or bypass the animation and go directly to the prize award at the end of the animation.

The watermarked virtual pull-tab gaming system and method can support a wide variety of game types, in addition to the ones described above. By way of example and not of limitation, the games type that include slot machine games, video lottery games, poker, blackjack, skill-based wagering games, and other such game types. With respect to security and/or cybersecurity issues, the illustrative systems and methods described may require different security measures that conform to jurisdictional gaming requirements.

It is to be understood that the detailed description of illustrative embodiments are provided for illustrative purposes. Thus, the degree of software modularity for the transactional system and method presented above may evolve to benefit from the improved performance and lower cost of the future hardware components that meet the system and method requirements presented. The scope of the claims is not limited to these specific embodiments or examples. Therefore, various process limitations, elements, details, and uses may differ from those just described, or be expanded on or implemented using technologies not yet commercially viable, and yet still be within the inventive concepts of the present disclosure. The scope of the invention is determined by the following claims and their legal equivalents.

What is claimed is:

1. A watermarked pull-tab gaming system comprising:
a wagering system that generates an electronic pull-tab deck that includes a plurality of electronic pull-tab tickets, wherein the electronic pull-tab deck includes a plurality of watermarked winning electronic pull-tab tickets having a non-zero win value;
a plurality of gaming devices communicatively coupled to the wagering system, wherein each gaming device includes a processor and a memory;
an electronic pull-tab ticket request generated by a gaming device, in which the gaming device receives an electronic pull-tab ticket in response to the electronic pull-tab ticket request;
wherein the electronic pull-tab ticket includes a watermark identifier;
a watermark table stored on the gaming device, wherein the watermark table indicates a type of watermark and a placement of the watermark for a total prize award on the gaming device;
wherein the gaming device displays the watermark as indicated by the watermark table; and
a reveal animation that corresponds to the electronic pull-tab ticket having a non-zero value, wherein the gaming device presents the reveal animation after the gaming device displays the watermark.

2. The system of claim 1 wherein the electronic pull-tab ticket having the watermark identifier includes a total prize and a plurality of display information associated with the total prize.

3. The system of claim 1 wherein the watermark is displayed as a grid.

4. The system of claim 3 wherein the electronic pull-tab ticket having the watermark identifier and the watermark table associated with the gaming device determines one or more highlighted portions of the grid watermark.

5. The system of claim 1 wherein the watermark is embedded in a game symbol.

6. The system of claim 1 wherein the watermark is proximate to a game symbol.

7. The system of claim 1 wherein the reveal animation includes at least one of a screen shift, a foreground display, and a background display.

8. The system of claim 1 wherein the reveal animation includes an overlaid feature, wherein the overlaid feature is displayed on top of at least one of the plurality of game symbol display positions.

9. The system of claim 1 wherein the reveal animation includes one or more placeholder symbols, in which the placeholder symbol covers a game symbol and revealing the game symbol when the placeholder symbol is removed.

10. The system of claim 1 wherein the electronic pull-tab ticket includes a non-zero paytable modification value, and the gaming device displays a paytable modification animation corresponding to the received electronic pull-tab ticket non-zero paytable modification value.

11. A watermarked pull-tab gaming method comprising:
providing a wagering system that generates an electronic pull-tab deck that includes a plurality of electronic pull-tab tickets, wherein the electronic pull-tab deck includes a plurality of watermarked winning electronic pull-tab tickets having a non-zero win value;
communicatively coupling a plurality of gaming devices to the wagering system, wherein each gaming device includes a processor and a memory;
generating, by a gaming device, an electronic pull-tab ticket request, in which the gaming device receives an electronic pull-tab ticket in response to the electronic pull-tab ticket request, wherein the electronic pull-tab ticket includes a watermark identifier;
storing, on the gaming device, a watermark table, in which the watermark table indicates a type of watermark and a placement of the watermark for a total prize award on the gaming device, wherein the gaming device displays the watermark as indicated by the watermark table; and
presenting a reveal animation that corresponds to the electronic pull-tab ticket having a non-zero value, wherein the gaming device presents the reveal animation after the gaming device displays the watermark.

12. The method of claim 11 wherein the electronic pull-tab ticket having the watermark identifier includes a total prize and a plurality of display information associated with the total prize.

13. The method of claim 11 wherein the watermark is displayed as a grid.

14. The method of claim 13 wherein the electronic pull-tab ticket having the watermark identifier and the watermark table associated with the gaming device determines one or more highlighted portions of the grid watermark.

15. The method of claim 11 wherein the watermark is embedded in a game symbol.

16. The method of claim 11 wherein the watermark is proximate to a game symbol.

17. The method of claim 11 wherein the reveal animation includes at least one of a screen shift, a foreground display, and a background display.

18. The method of claim 11 wherein the reveal animation includes an overlaid feature, wherein the overlaid feature is displayed on top of at least one of the plurality of game symbol display positions.

19. The method of claim 11 wherein the reveal animation includes one or more placeholder symbols, in which the placeholder symbol covers a game symbol and revealing the game symbol when the placeholder symbol is removed.

20. The method of claim 11 wherein the electronic pull-tab ticket includes a non-zero paytable modification value, and the gaming device displays a paytable modification animation corresponding to the received electronic pull-tab ticket non-zero paytable modification value.
